(19) United States
(12) Patent Application Publication
(10) Pub. No.: US 2026/0278408 A1
(43) Pub. Date: Sep. 17, 2026

(54) DEPLOYING AUTONOMOUS SOFTWARE AGENTS AND RETRIEVING KNOWLEDGE TO CONFIGURE AN INDEPENDENT VIRTUAL MACHINE COMPUTING ENVIRONMENT

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US)

(21) Appl. No.: 19/561,170

(22) Filed: Mar. 9, 2026

Related U.S. Application Data
(60) Provisional application No. 63/770,816, filed on Mar. 12, 2025.

(51) Int. Cl. G06N 5/022

(52) U.S. Cl. CPC G06N 5/022

(57) ABSTRACT

The present disclosure relates to systems, methods, and non-transitory computer-readable media that provide an autonomous software agent with relevant knowledge items to execute a software task. In particular, the disclosed systems provide a knowledge creation option to create software composition instructions for an independent virtual machine computing environment to reference across different development sessions. Moreover, the disclosed systems receive knowledge items pertaining to a knowledge trigger and further receive a prompt to deploy an autonomous software agent within the independent virtual machine computing environment. Additionally, the disclosed systems determine that the software task indicates a knowledge trigger and provide the knowledge items to the autonomous software agent to aid in executing the software task.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, and operational flexibility.

### SUMMARY

One or more embodiments described herein provide benefits and/or solve one or more problems in the art with systems, methods, and non-transitory computer-readable media that deploy autonomous software agents and execute software tasks utilizing a knowledge input (e.g., a knowledge). To illustrate, in one or more embodiments, the disclosed systems receive knowledge items pertaining to a knowledge trigger. Moreover, in one or more embodiments, the disclosed systems receive a request to activate an autonomous software agent to perform a software task. Specifically, in response to the request, the disclosed systems deploy an autonomous software agent to perform the software task (e.g., generate computer code, create an application end-to-end, fine-tune an artificial intelligence model, debug computer code, etc.).

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system receiving a knowledge to customize an autonomous software agent in accordance with one or more implementations;

FIG. 2 illustrates an example diagram of the autonomous software agent system performing an initial knowledge transfer to receive one or more configuration options for an independent virtual machine computing environment in accordance with one or more implementations;

FIG. 3 illustrates an example diagram of the autonomous software agent system determining a relevant knowledge trigger within a knowledge library in accordance with one or more implementations;

FIG. 4 illustrates an example diagram of the autonomous software agent system deploying an autonomous software agent in accordance with one or more implementations;

FIGS. 5A-5G illustrate example graphical user interfaces of the autonomous software agent system providing a knowledge transfer interface and storing various knowledges in accordance with one or more implementations;

FIG. 6 illustrates an example diagram of an architectural layer design of the autonomous software agent system which accesses various artificial intelligence models to enable an independent virtual machine computing environment of an autonomous software agent in accordance with one or more implementations;

FIG. 7 illustrates an example diagram of a virtual private cloud housing an independent virtual machine computing environment that is in communication with an autonomous agent model backend in accordance with one or more implementations;

FIG. 8 illustrates an example diagram of a frontend layer interacting with an autonomous software agent system ingestion layer and a virtual private cloud in accordance with one or more implementations;

FIG. 9 illustrates an example environment of the autonomous software agent system in accordance with one or more implementations;

FIG. 10 illustrates an example series of acts for determining a software task indicates a knowledge trigger and providing knowledge items to an autonomous software agent in accordance with one or more implementations;

FIG. 11 illustrates an example series of acts for receiving different knowledges and deploying an autonomous software agent in accordance with one or more implementations; and

FIG. 12 illustrates a block diagram of an exemplary computing device in accordance with one or more implementations.

### DETAILED DESCRIPTION

One or more embodiments described herein includes an autonomous software agent system that receives knowledges and activates a knowledge in response to a task of an autonomous software agent triggering the knowledge. To illustrate, in one or more embodiments, an autonomous software agent system 100 deploys an autonomous software agent to independently complete software development tasks such as writing computer code tests, adding features to an existing code repository, adding functionality to an existing codebase, developing prototypes, and building integrations between software applications.

In one or more embodiments, a task/sub-task of a software task indicates a knowledge trigger, and the autonomous software agent system 100 provides knowledge to an autonomous software agent executing the software task. In particular, the autonomous software agent system 100 customizes an independent virtual machine computing environment and the autonomous software agent is enabled to access customized computer code documentation, one or more internal code libraries, contextual tips, or one or more skills. In other words, the autonomous software agent system 100 deploys one or more autonomous software agents to independently perform a variety of non-trivial tasks and provides customizable knowledge items for tasks that indicate certain knowledge triggers, which enhances overall efficiency, accuracy, and operational flexibility of code development environments.

In some embodiments, the autonomous software agent system 100 provides a knowledge transfer interface to receive knowledges. In particular, the autonomous software agent system 100 receives knowledge items that correspond with knowledge triggers (e.g., user-specified triggers) and stores these knowledge items and knowledge triggers within a knowledge library. In one or more embodiments, the autonomous software agent system 100 can retrieve one or more knowledges stored in the knowledge library across any relevant development session.

In some embodiments, the autonomous software agent system 100 provides options for configuring an initial knowledge state. In particular, the autonomous software agent system 100 receives a knowledge comprising at least one of computer code documentation, internal code libraries, contextual tips for operating within the internal code libraries, or skills for operating within the internal code libraries. Accordingly, the autonomous software agent system 100 can deploy an autonomous software agent according to a configured initial knowledge state.

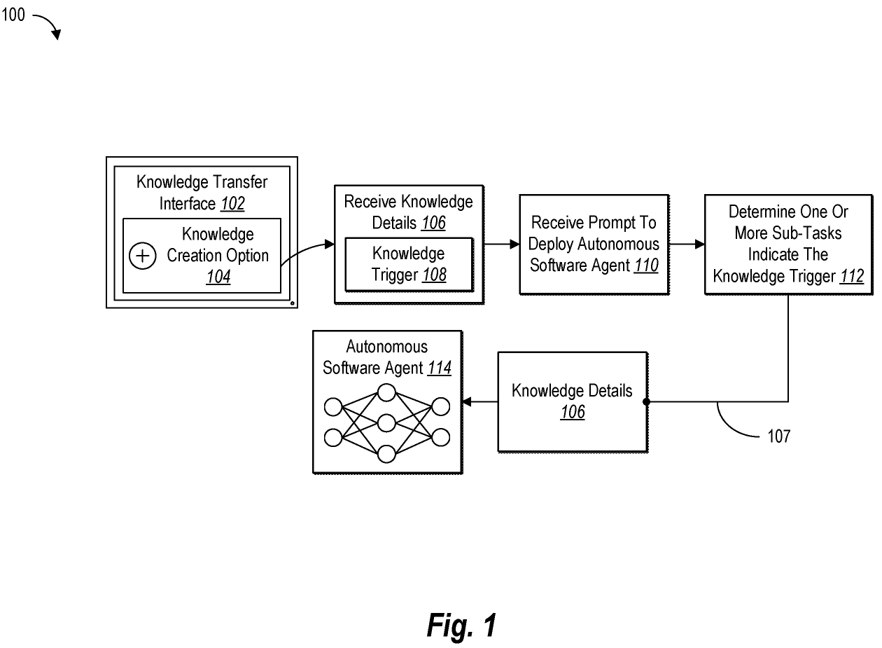

FIG. 1 illustrates an overview diagram of the autonomous software agent system 100 receiving a selection of a knowledge creation option in accordance with one or more embodiments. For example, FIG. 1 shows the autonomous software agent system 100 providing a knowledge transfer interface 102 and a knowledge creation option 104 within the knowledge transfer interface 102. In one or more embodiments, the knowledge transfer interface 102 refers to a graphical user interface that receives knowledges. In particular, the knowledge transfer interface 102 displays a knowledge creation option and options to modify created knowledges.

As shown in FIG. 1, the autonomous software agent system 100 receives a selection of the knowledge creation option 104 and performs an act of receiving knowledge items 106. In some embodiments, the knowledge items 106 refer to knowledge or a form of information to configure a development environment of an autonomous software agent (e.g., based on specific triggers that are relevant to a development session). To illustrate, the knowledge items 106 include access to computer code documentation, access to one or more internal code libraries, access to contextual tips for operating within the one or more internal code libraries, or access to one or more skills.

Furthermore, FIG. 1 shows the autonomous software agent system 100 receiving a knowledge trigger 108. In one or more embodiments, the knowledge trigger 108 refers to a context or a cue (e.g., from executing a sub-task/task of a software task that is indicated by a prompt) that causes a knowledge (e.g., knowledge items corresponding to the knowledge) to be recalled by an autonomous software agent. In other words, the autonomous software agent system 100 causes an autonomous software agent to receive the knowledge items 106 in response to a context/cue of a sub-task/task indicating the knowledge trigger 108.

Knowledge items refers to a collection of information, data, content, or representations thereof that are made available to, accessible by, or otherwise usable by an agent, model, or computing process for the purpose of informing, influencing, constraining, or enhancing operations, outputs, reasoning, decision-making, or task performance. Unless expressly limited, the knowledge items encompass both raw information and processed representations thereof, regardless of format, storage medium, origin, or method of retrieval.

Knowledge items may include, without limitation, structured data such as databases, tables, schemas, and records; semi-structured data such as JSON, XML, or tagged documents; unstructured data such as text documents, manuals, guides, messages, and transcripts; code artifacts including source code, configuration files, and scripts; documentation such as product guides, policies, and specifications; media content including images, audio, and video and associated metadata; derived data such as embeddings, vectors, indexes, summaries, and annotations; metadata describing any of the foregoing; and any combination thereof.

Knowledge items may be stored in local memory, remote storage, third-party systems, repositories, document stores, vector databases, or other data storage mechanisms. Such knowledge may be static, periodically updated, dynamically generated, or continuously synchronized from one or more sources. In one or more embodiments, knowledge items further include machine-generated or transformed representations derived from source materials, including but not limited to embeddings, feature vectors, tokenized representations, knowledge graphs, indexed structures, or other machine-interpretable formats. Knowledge may be organized into one or more logical groupings, collections, domains, namespaces, or repositories associated with a particular user, organization, project, application, environment, or access control policy.

FIG. 1 further shows the autonomous software agent system 100 performing an act 110 of receiving a prompt to deploy an autonomous software agent. In some embodiments, the autonomous software agent system 100 receives the prompt (e.g., via a chat interface between a user and the autonomous software agent system 100). In particular, the autonomous software agent system 100 provides a chat interface via a web browser, or a web application.

In one or more embodiments, the autonomous software agent system 100 further performs an act of deploying an autonomous software agent (e.g., a cloned virtual machine that is isolated and can perform tasks siloed from other virtual machine computing devices). In particular, the autonomous software agent system 100 deploys the autonomous software agent within an independent virtual machine computing environment and generates and runs code in its own isolated environment.

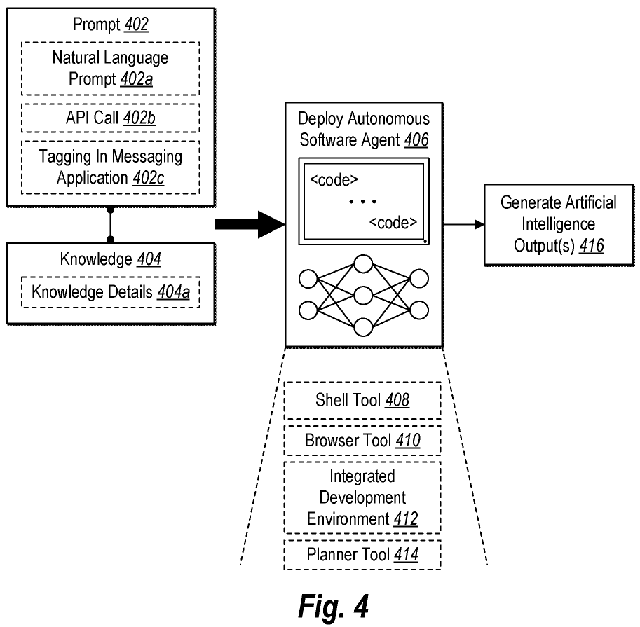

In other words, the autonomous software agent exists independently of a computing device of a user who submitted a prompt to deploy the autonomous software agent and performs tasks based on knowledge that is provided to it. Moreover, the autonomous software agent system 100 further provides to the autonomous software agent computer software composition tools. Details pertaining to the computer software composition tools are given in more detail below in the description of FIG. 4.

In one or more embodiments, the independent virtual machine computing environment refers to a software-based simulation that independently runs its own operating system and applications as a standalone machine. For example, a virtual machine computing environment refers to a software-implemented computational environment that emulates a physical computing system and provides an isolated, executable runtime environment for code generation, execution, testing, modification, or orchestration by the autonomous software agent system 100. In one or more embodiments, the virtual machine computing environment may operate as a system-level virtualization layer (e.g., hypervisor-based virtual machine), an operating system–level container, a language runtime virtual machine, or a custom execution sandbox, and may be dynamically provisioned, configured, and decommissioned under control of the virtual machine computing environment. Thus, a deployed autonomous software agent independently leverages its own independent computing environment.

In one or more embodiments, the autonomous software agent system 100 provides the autonomous software agent with its own software development environment (e.g., the independent virtual machine computing environment with access to the computer software composition tools) to perform individualized tasks and not merely supplementary tasks (e.g., the autonomous software agent can deploy its own codebase by replicating an existing codebase, make changes to an existing codebase, implement changes to a codebase, and run tests for computer code generated by an autonomous software agent).

In some embodiments, the autonomous software agent includes a set of artificial intelligence models. In particular, the autonomous software agent includes one or more machine learning models, neural networks, large language models, chain-of-thought reasoning models, and/or vision-language models. Thus, the autonomous software agent system 100 deploys an autonomous software agent that operates within an independent virtual machine computing device with various machine learning components used to analyze, process, and generate information.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that are tunable based on training data to improve the model for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence.

A language model is called a large language model (LLM) when it is trained on an enormous amount of data (e.g., a threshold amount of data) and/or has a large number of parameters. These models have capabilities ranging from writing a simple essay to generating complex computer codes – all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include a LLM trained using reinforcement learning techniques that enable the LLM to refine its reasoning skills through iterative feedback.

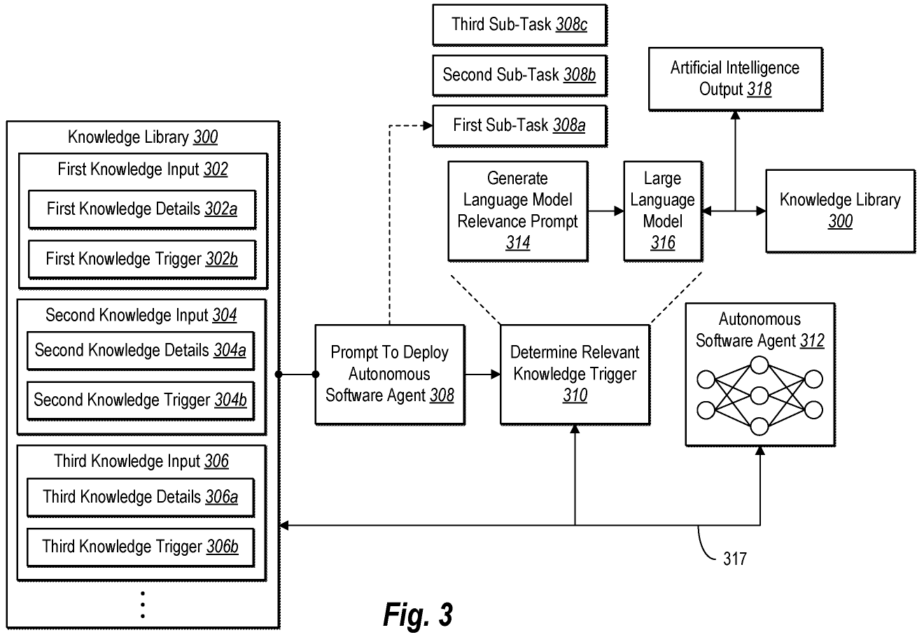

Additionally, FIG. 1 shows the autonomous software agent system 100 performing an act 112 of determining one or more sub-tasks that indicate the knowledge trigger 108. Details regarding the act 112 of determining a sub-task indicating the knowledge trigger 108 are described in more detail below in the description of FIG. 3. As shown in FIG. 1, the autonomous software agent system 100 performs the act 112 of determining a sub-task indicating the knowledge trigger 108 and performs an act 107 of providing the knowledge items 106 to an autonomous software agent 114. In doing so, the autonomous software agent system 100 enables/customizes an independent virtual machine computing environment of the autonomous software agent 114 with the knowledge items 106.

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer’s device in order to supplement developer work. In other words, existing systems merely act as a co-pilot to a developer. Accordingly, existing systems suffer from computational inefficiencies of attempting to integrate a code development assistant into a developer’s workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer’s task, however it is often difficult or impossible to follow/understand the thought process of existing code generation systems writing computer code. Often, existing code generation systems are a black box that receive instructions and output computer code (e.g., which results in difficulties understanding how the existing code generation system arrived at its answer). As such, modifying intermediate steps of a (supplementary) software coding task performed by existing code generation systems is often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck operating as a co-pilot developer to merely supplement a software developer’s workflow.

In one or more embodiments, the autonomous software agent system 100 provides several improvements over conventional systems in relation to technical accuracy, computational efficiency, and operational flexibility. In contrast to existing systems, which require heavily involved guidance, prompting, monitoring, and the use of a developer’s device (in order to supplement developer work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse context of other ongoing tasks. Specifically, the autonomous software agent system 100 silos/isolates autonomous software agents (e.g., to operate independently with fully featured computer software composition tools discussed in more detail in FIG. 4) such that the autonomous software agents can accurately perform their assigned software tasks without being bogged down by additional information.

In one or more embodiments, the autonomous software agent system 100 further improves upon technical inaccuracies by analyzing contextual windows of a plurality of sub-tasks while (or before) executing a software task. In some embodiments, the autonomous software agent system 100 determines a contextual window (e.g., a cue) of a sub-task points to a knowledge trigger in a knowledge library. In detecting a specific knowledge trigger for a specific sub-task, the autonomous software agent system 100 provides knowledge items (e.g., included as part of a knowledge) to an autonomous software agent.

In doing so, the autonomous software agent system 100 improves the technical accuracy of the autonomous software agent executing a software task. In particular, the autonomous software agent system 100 provides the autonomous software agent with access to computer code documentation, one or more internal code libraries, contextual tips for operating within the one or more internal code libraries, and/or one or more skills, which improves the success rate of executing the software task (e.g., specialized skills, contextual tips, or access to specific sources assist the autonomous software agent in more accurately accomplishing a software task).

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment, how to generate artificial intelligence outputs (e.g., computer code) that match a determined context, and how to choose between various artificial intelligence models to accomplish various software tasks. In some embodiments, the autonomous software agent system 100 allows a user computing device to configure an autonomous software agent environment (e.g., via knowledges stored in a knowledge library) and then deploys the autonomous software agent to complete a software task, thus improving the technical accuracy of artificial intelligence agents performing software tasks (e.g., relative to existing systems).

In one or more embodiments, the autonomous software agent system 100 enables a user computing device to follow the work of an autonomous software agent as it performs a software coding task. For example, the autonomous software agent system 100 displays commands submitted by the autonomous software agent via a terminal, computer code being written by the autonomous software agent via an editor, and computer code being debugged by the autonomous software agent. As such, the autonomous software agent system 100 enables a user of a computing device to more accurately understand the manner in which an autonomous software agent arrived at a final result (e.g., the user computing device can follow the autonomous software agent in real-time).

Moreover, in some embodiments, the autonomous software agent system 100 prompts (e.g., via a chat interface) a user computing device to save a knowledge in a knowledge library. In particular, from executing a software task, the autonomous software agent system 100 can identify certain inputs and suggest a computing device to store the inputs as knowledge for future development session. In doing so, the autonomous software agent system 100 improves the technical accuracy of future development sessions by potentially drawing from memories/knowledge inputs that were helpful in successfully accomplishing a previous software task.

Relatedly, the autonomous software agent system 100 also improves computational efficiency of software tasks by enabling options for a user of a computing device to follow an autonomous software agent executing a software task. In particular, as mentioned, the autonomous software agent can operate independently, and in some instances, a user can intervene or understand the steps/thought processes of an autonomous software agent by following the autonomous software agent as it switches between using different computer software composition tools.

In particular, a user of a computing device can follow an autonomous software agent as it switches between different computer software composition tools to execute a software task. In doing so, the autonomous software agent system 100 saves computational resources and time as a user can more efficiently understand the process of an autonomous software agent (e.g., as it performs a task or after it performs a task) and the user can intervene at one or more points in the development session to aid/assist an autonomous software agent.

Moreover, as mentioned above, the autonomous software agent system 100 can provide knowledge items to an autonomous software agent in response to a knowledge trigger being detected. In particular, the autonomous software agent system 100 improves computational efficiency by quickly accessing relevant computer code documentation, relevant internal code libraries, relevant contextual tips for operating within the one or more internal code libraries, or relevant/specialized skills for executing a sub-task that indicates a knowledge trigger.

As also mentioned above, the autonomous software agent system 100 can prompt a user computing device to save certain inputs as knowledges for future development sessions. In doing so, the autonomous software agent system 100 also improves computational efficiency as saved knowledges (e.g., based on the autonomous software agent system 100 prompting the user computing device) allow the autonomous software agent system 100 to more seamlessly move through software development pipelines when encountering types of software tasks that are similar to previously executed software tasks.

Furthermore, the autonomous software agent system 100 improves computational efficiency by enabling a user computing device to continue to delegate entire non-trivial software coding tasks to the autonomous software agent while the autonomous software agent is already working completely asynchronously. As the autonomous software agent is executing a software coding task, a user can delegate multiple additional autonomous software agents to perform additional software tasks. Thus, the autonomous software agent system 100 enables large scale parallelization of tasks.

In one or more embodiments, the autonomous software agent system 100 further improves upon operational inflexibilities. In contrast to existing systems, which are rigidly tied to code supplementation, the autonomous software agent system 100 deploys an autonomous software agent that operates within an independent virtual machine computing environment and further allows a user to monitor/modify the progress of the autonomous software agent (if so desired). Moreover, because the autonomous software agent system 100 deploys an autonomous software agent that is provided with various development box tools, the autonomous software agent acts as an advanced reasoning tool to complete non-trivial tasks. Accordingly, the autonomous software agent system 100 enhances the flexibility of operations in performing code generation tasks relative to existing systems.

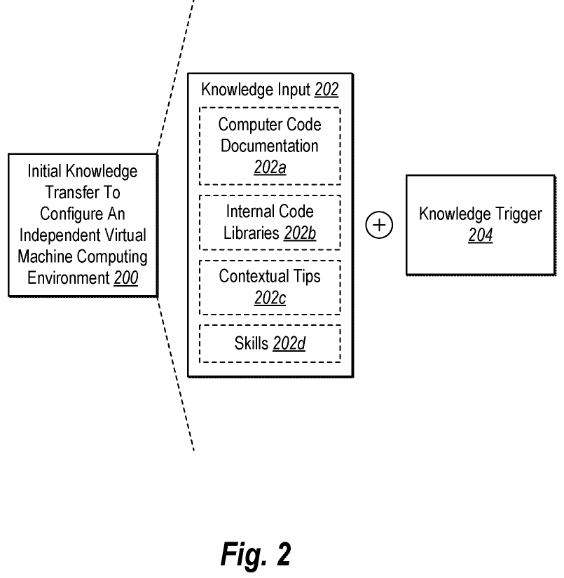

FIG. 2 illustrates the autonomous software agent system 100 receiving a knowledge and a knowledge trigger in accordance with one or more embodiments. For example, FIG. 2 shows the autonomous software agent system 100 performing an act 200 of receiving an initial knowledge transfer to configure an independent virtual machine computing environment (e.g., for future development sessions).

As shown in FIG. 2, the autonomous software agent system 100 receives the initial knowledge transfer as a knowledge 202. In one or more embodiments, the initial knowledge transfer refers to an initial configuration by a user computing device. For example, the initial knowledge transfer refers to a user computing device transferring relevant information/data packets to the autonomous software agent system 100. In doing so, the autonomous software agent system 100 can accurately determine the correct context for providing certain types of knowledges to an autonomous software agent. In other words, the initial knowledge transfer assists the autonomous software agent system 100 in improving the overall efficiency and accuracy in future development sessions of one or more autonomous software agents.

In some embodiments, the knowledge 202 refers to repeatable prompts (e.g., system prompts, also known as playbooks). In particular, the knowledge 202 can include repeatable prompts such as common computer bugs, solutions for the common bugs, code conformance practices, deployment workflows, testing workflows, and/or how an autonomous software agent should interact with proprietary tools.

In some embodiments, the knowledge 202 includes at least one of computer code documentation 202a, internal code libraries 202b, contextual tips 202c, or skills 202d. In one or more embodiments, the computer code documentation 202a refers to written documents that explain how computer code works and how to utilize the computer code. For example, the computer code documentation 202a can include comments inside the code, README files, API documents (e.g., application programming interface documents for interacting with application endpoints), and setup/usage documents. In particular, the computer code documentation 202a can help an autonomous software agent understand, maintain, and correctly use software computer code (e.g., in an internal code library).

In one or more embodiments, the internal code libraries 202b (e.g., a code repository) refer to a centralized location where software computer code is stored, managed, and controlled (e.g., controlled for different deployment versions such as development, web application, cloud, etc.). In particular, the internal code libraries 202b include computer code, computer code documentation (e.g., files explaining how to use, setup, and contribute to one or more projects), configuration files (e.g., environment configuration, application configuration, deployment configuration, etc.), and assets (e.g., images, CSS files, JavaScript files, fonts, external libraries, audio/video files, etc.).

In one or more embodiments, the contextual tips 202c refer to guidelines that explain how to effectively use the internal code libraries 202b. For example, the contextual tips 202c include guidelines for an autonomous software agent, such as which functions (e.g., within a code repository) to prefer or to avoid, common pitfalls that are encountered when operating within the internal code libraries 202b, and performance or security considerations. In other words, the contextual tips 202c provide guidance to an autonomous software agent to prevent mistakes and help the autonomous software agent use internal tools efficiently.

In one or more embodiments, the skills 202d refer to specialized skills for an autonomous software agent system to further customize its development environment to more accurately and efficiently execute a task. For example, the skills 202d can include installing language runtimes within the development environment of the autonomous software agent, configuring environment variables, connecting to internal services (e.g., databases, APIs, authentication systems), and resolving code dependency conflicts. In other words, the skills 202d assist the autonomous software agent in matching a software task’s requirements such that software programs run correctly.

As further shown in FIG. 2, as part of the knowledge 202, the autonomous software agent system 100 also receives a knowledge trigger 204. As discussed above, the knowledge trigger 204 refers to a context or a cue from executing a sub-task/task of a software task (e.g., indicated by a prompt) that causes the knowledge 202 (e.g., knowledge items corresponding to the knowledge) to be recalled by an autonomous software agent.

In some embodiments, the autonomous software agent system 100 can pin the knowledge 202 to a specific set or subset of code repositories. In particular, the autonomous software agent system 100 can receive an initial knowledge transfer via the knowledge 202 and further receive a specific pin/association of the knowledge 202 with a specific set of code repositories (e.g., a subset of the internal code libraries 202b). In other words, the autonomous software agent system 100 can recall specific knowledge/memories to customize/configure an independent virtual machine computing environment when a software task points to/indicates the specific set of code repositories.

Moreover, in some embodiments, the autonomous software agent system 100 can receive an input that the knowledge 202 is not pinned to any specific code repository. In such cases, the autonomous software agent system 100 retrieves the knowledge 202 in response to a current context of a software task being relevant to the knowledge 202. Additionally, in some embodiments, the autonomous software agent system 100 can receive an input that pins the knowledge 202 to all connected code repositories. In such cases, the autonomous software agent system 100 can recall the knowledge 202 in response to a software task involving any of the connected code repositories.

In some embodiments, the autonomous software agent system 100 leverages the knowledge 202 such that it is targeted at a specific workflow or action of a software task. In particular, the autonomous software agent system 100 provides the knowledge 202 to an autonomous software agent and causes the autonomous software agent to be aware of the contents within the knowledge 202.

FIG. 3 illustrates the autonomous software agent system 100 determining a relevant knowledge trigger from a knowledge library in accordance with one or more embodiments. For example, FIG. 3 shows the autonomous software agent system 100 accessing a knowledge library 300. In one or more embodiments, the knowledge library 300 refers to a database storage tailored specifically for knowledges. In particular, the knowledge library 300 refers to a database that stores a plurality of knowledge items and a plurality of knowledge triggers. For example, the autonomous software agent system 100 stores knowledges within the knowledge library 300 in response to receiving selections of a knowledge creation option (e.g., discussed above).

In one or more embodiments, the autonomous software agent system 100 organizes knowledge (e.g., knowledge items) within a hierarchical scope model. For example, knowledge items may be designated as session-scoped knowledge, repository-scoped knowledge, workspace-scoped knowledge, organization-scoped knowledge, or global knowledge. In some embodiments, global knowledge applies across all development sessions and repositories accessible to a user computing device, whereas repository-scoped knowledge is restricted to a particular code repository or subset of repositories. Workspace-scoped or organization-scoped knowledge may be shared among a plurality of user computing devices associated with a common tenant, team, or enterprise account. In some embodiments, the autonomous software agent system 100 enforces precedence rules such that repository-scoped knowledge overrides global knowledge when conflicts arise, or such that organization-scoped knowledge supplements but does not replace repository-scoped knowledge. Accordingly, the knowledge library may store metadata defining scope, inheritance relationships, and priority rules for resolving overlapping knowledge items.

In one or more embodiments, the autonomous software agent system 100 enforces access control policies for knowledge retrieval. For example, knowledge items may be associated with role-based permissions, repository access permissions, tenant boundaries, or user-specific credentials. In some embodiments, when determining whether a knowledge trigger applies, the autonomous software agent system 100 filters candidate knowledge items based on authentication credentials and authorization policies associated with the development session. In this manner, the autonomous software agent system 100 prevents retrieval of knowledge items that are not accessible to the user computing device or that are restricted to certain roles within an organization. In some embodiments, knowledge retrieval is logged and auditable, such that administrative users can review when specific knowledge items were injected into an autonomous software agent session.

Moreover, in some embodiments, the knowledge library 300 refers to a library that stores discrete knowledge items for an autonomous software agent to reference over multiple development sessions. In particular, the knowledge library 300 typically includes a wide breadth of information pertinent to a target organization and allows a software development team to accurately and efficiently leverage autonomous software agents to execute non-trivial software tasks.

Moreover, in some embodiments, the autonomous software agent system 100 prompts a user computing device that an input should be stored in the knowledge library 300. In such situations, if the autonomous software agent system 100 receives confirmation from the user computing device that an input should be stored in the knowledge library 300, then the autonomous software agent system 100 stores the input within the knowledge library 300. In other words, the autonomous software agent system 100 can receive knowledges based on inputs from a user computing device and/or based on artificial intelligence suggestions for the user computing device to store an input as knowledge in the knowledge library 300.

As shown in FIG. 3, the autonomous software agent system 100 accesses the knowledge library 300 with first knowledge 302 (e.g., that includes first knowledge items 302a and a first knowledge trigger 302b), second knowledge 304 (e.g., that includes second knowledge items 304a and a second knowledge trigger 304b), and third knowledge 306 (e.g., that includes third knowledge items 306a and a third knowledge trigger 306b). As discussed above, the knowledge items include a variety of different details such as access to computer code documentation, access to one or more internal code libraries, access to contextual tips for operating within the one or more internal code libraries, and/or access to one or more skills.

In one or more embodiments, the autonomous software agent system 100 detects potential conflicts between multiple knowledge items triggered during execution of a software task. For example, two knowledge items may contain overlapping or contradictory instructions applicable to the same sub-task. In some embodiments, the autonomous software agent system 100 applies arbitration logic to resolve such conflicts based on priority metadata, scope hierarchy, recency of modification, usage frequency, or explicit precedence rules. In some embodiments, the autonomous software agent system 100 generates an explanatory prompt to a user computing device identifying the conflict and requesting resolution. In other embodiments, the autonomous software agent system 100 merges non-conflicting portions of knowledge items and suppresses conflicting instructions according to predefined policies.

In one or more embodiments, the autonomous software agent system 100 can receive knowledge triggers relating to a variety of different contexts. For example, the autonomous software agent system 100 can receive the first knowledge trigger 302b of a software sub-task indicating a specific code repository. In other words, the first knowledge trigger 302b indicates that if a sub-task involves working within code repository X, then the autonomous software agent system 100 transfers the first knowledge items 302a to an autonomous software agent executing the software sub-task. To illustrate, the autonomous software agent system 100 transfers computer code documentation customized for operating within code repository X to the autonomous software agent executing the software sub-task.

In one or more embodiments, the autonomous software agent system 100 can receive the second knowledge trigger 304b of a software sub-task indicating conversion of a first computer code language to a second computer code language. In other words, the second knowledge trigger 304b indicates that if a sub-task involves translating a computer code language X to computer code language Y, then the autonomous software agent system 100 transfers the second knowledge items 304a to an autonomous software agent performing the task. To illustrate, the autonomous software agent system 100 transfers a specialized skill to convert computer code language X to computer code language Y to the autonomous software agent.

In one or more embodiments, the autonomous software agent system 100 can receive the third knowledge trigger 306b of a software sub-task indicating a deployment of a local application. In other words, the third knowledge trigger 306b indicates that if a sub-task involves deployment of a specific application (e.g., local application X), then the autonomous software agent system 100 transfers the third knowledge items 306a to an autonomous software agent performing the task. To illustrate, the autonomous software agent system 100 transfers contextual tips and a set of customized tests to deploy the local application to the autonomous software agent.

In one or more embodiments, the autonomous software agent system 100 can receive a fourth knowledge trigger of a software sub-task indicating a data manipulation. In other words, the fourth knowledge trigger indicates that if a sub-task involves a specific data manipulation, then the autonomous software agent system 100 transfers fourth knowledge items to an autonomous software agent performing the task. To illustrate, the autonomous software agent system 100 transfers additional contextual tips and an additional specialized skill to perform the data manipulation to the autonomous software agent.

As shown in FIG. 3, the autonomous software agent system 100 receives a prompt 308 to deploy an autonomous software agent. In response, the autonomous software agent system 100 deploys the autonomous software agent to execute a software task indicated by the prompt 308. For example, the autonomous software agent system 100 deploys the autonomous software agent to execute a software task that includes a plurality of sub-tasks. In particular, for each sub-task, the autonomous software agent system 100 determines whether a relevant knowledge is triggered in the knowledge library 300.

In one or more embodiments, the software task refers to a defined unit of work in a software project to be planned, assigned, executed and/or completed. For example, the software task refers to a specific software component for the autonomous software agent system 100 to build, change, fix, and/or maintain based on requirements of the prompt 308. In other words, the software task refers to a discrete, actionable piece of work that contributes to the development, maintenance, or improvement of a software system.

More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

As shown in FIG. 3, the autonomous software agent system 100 performs an act 310 of determining a relevant knowledge trigger. In some embodiments, the prompt 308 includes a first sub-task 308a, a second sub-task 308b, and a third sub-task 308c. Moreover, in some embodiments, the autonomous software agent system 100 transmits contextual data of each sub-task to a large language model to determine a relevant knowledge trigger (if any).

In one or more embodiments, the autonomous software agent system 100 performs the act 310 of determining a relevant knowledge trigger when a certain context of a software task is relevant. In other words, in some embodiments, the autonomous software agent system 100 does not retrieve all relevant knowledge for all sub-tasks at the beginning of deploying an autonomous software agent, rather, the autonomous software agent system 100 retrieves a knowledge in response to encountering a relevant knowledge trigger. Accordingly, in one or more embodiments, the autonomous software agent system 100 provides guidance instructions to a user computing device to provide targeted, specific details for a knowledge trigger (e.g., corresponding to a knowledge), such that the autonomous software agent system 100 recalls a relevant knowledge when encountering highly relevant knowledge trigger. In other words, the more detailed and specific the knowledge trigger the better, as it improves the overall computational efficiency of an autonomous software agent retrieving relevant knowledges.

As shown in FIG. 3, the autonomous software agent system 100 generates a language model relevance prompt 314 for the first sub-task 308a. In particular, FIG. 3 shows the autonomous software agent system 100 transmitting the language model relevance prompt 314 to a large language model 316. In one or more embodiments, the autonomous software agent system 100 utilizes the large language model 316 that leverages retrieval-augmented generation (RAG) to determine a relevance of the first sub-task 308a. In some embodiments, retrieval-augmented generation refers to retrieving relevant information from an external database or knowledge source in context of the prompt 308.

In some embodiments, the autonomous software agent system 100 can utilize RAG (e.g., which includes using the large language model 316) to generate a response (e.g., determining a relevant knowledge trigger in the knowledge library 300) by leveraging both the retrieved information (from an external source such as from the first sub-task 308a that the autonomous software agent system 100 is executing) and its own internal knowledge base (e.g., the knowledge library 300). In particular, the autonomous software agent system 100 leverages RAG, which includes an input query, information retrieval, and response generation to perform a task of determining the relevance of a sub-task.

In one or more embodiments, the autonomous software agent system 100 generates the language model relevance prompt 314. For example, the language model relevance prompt 314 includes guidance instructions such as the context of a current sub-task, the prompt 308, information pertaining to the knowledge library 300 (e.g., how to access the knowledge triggers within the knowledge library 300) and information to determine which knowledge trigger (if any) is applicable to the context of the current sub-task. In some embodiments, the autonomous software agent system 100 directly provides metadata/data packets relating to the knowledge triggers in the knowledge library 300 to the large language model 316 to determine a relevant knowledge trigger.

In some embodiments, the autonomous software agent system 100 provides a generated language model relevance prompt and a context of a current sub-task to the large language model 316, and the large language model 316 generates an artificial intelligence output 318. In particular, the autonomous software agent system 100 can use the large language model 316 to compare an embedding representation of the context of a current sub-task with embedding representations of knowledge triggers in the knowledge library 300. In doing so, the autonomous software agent system 100 can generate the artificial intelligence output 318 which indicates the most relevant knowledge trigger or that there are no relevant knowledge triggers (e.g., within a relevance threshold).

In some embodiments, the autonomous software agent system 100 determines there are no relevant knowledge triggers within a relevance threshold. In such cases, the autonomous software agent system 100 can request/prompt a user computing device to provide new knowledge items to fulfill a current sub-task that requires details that are not stored within the knowledge library 300.

In other words, the autonomous software agent system 100 can utilize the large language model 316 to compare the context of a current sub-task with a plurality of knowledge triggers in the knowledge library 300. Based on the comparison, the autonomous software agent system 100 can further use the large language model 316 to generate the artificial intelligence output 318 that points to a relevant knowledge trigger (e.g., with corresponding relevant knowledge items).

In one or more embodiments, the autonomous software agent system 100 further causes the large language model 316 to transmit the artificial intelligence output 318 to an autonomous software agent 312 executing the current sub-task. In doing so, the autonomous software agent system 100 then utilizes the autonomous software agent 312 to access knowledge items corresponding to the knowledge trigger (e.g., as indicated by the artificial intelligence output 318) or the autonomous software agent 312 does not access any knowledge items (e.g., if the artificial intelligence output 318 indicates that there are no relevant knowledge items).

Accordingly, the autonomous software agent system 100 can iteratively perform this process of utilizing the large language model 316 to determine a relevant knowledge trigger for different sub-tasks of a software task. As shown in FIG. 3, the autonomous software agent system 100 performs the act 310 of determining a relevant knowledge trigger and further performs an act 317 of providing a knowledge that corresponds to the determined relevant knowledge trigger to the autonomous software agent 312. In particular, the autonomous software agent system 100 provides a relevant knowledge from the knowledge library 300 to the autonomous software agent 312 by customizing an independent virtual machine computing environment. For example, the autonomous software agent system 100 tailors the independent virtual machine computing environment to have access to at least one of the computer code documentation, the internal code libraries, the contextual tips for operating within the internal code libraries, or the specialized skills.

In one or more embodiments, the autonomous software agent system 100 provides, via a graphical user interface, an indication of which knowledge items were retrieved during execution of a software task and why those knowledge items were triggered. For example, the autonomous software agent system 100 may display a matched memory trigger, a relevance score, or contextual snippets that contributed to retrieval. In some embodiments, the autonomous software agent system 100 logs retrieval events and associates them with specific sub-tasks, terminal commands, or code generation steps. Such retrieval transparency improves user trust, auditability, and debugging of development sessions.

FIG. 4 illustrates an overview of the autonomous software agent system 100 generating computer code by deploying an autonomous software agent in accordance with one or more embodiments. For example, FIG. 4 shows the autonomous software agent system 100 accessing/receiving a prompt 402. In particular, the prompt 402 refers to a natural language prompt 402a (from a user computing device), an application programming interface call 402b, and/or a tag/mention 402c in a third-party messaging application (e.g., between a plurality of users).

In some embodiments, via an API, a user computing device can build custom workflows using an API of the autonomous software agent system 100 and programmatically assign tasks for the autonomous software agent system 100 to perform. Further, with the API, users of computing devices can essentially plug in the autonomous software agent system 100 to any of their software development and internal tools.

In some embodiments, the autonomous software agent system 100 deploys an autonomous software agent in response to being triggered by a code editor. In particular, from another code editor/integrated development environment (IDE), users of computing devices who use visual studio code (or visual studio code forks) can assign tasks to the autonomous software agent system 100 directly from their code editor/IDE.

In some embodiments, the autonomous software agent system 100 can deploy an autonomous software agent in response to being tagged/mentioned in a third-party messaging application. In particular, users of computing devices can tag the autonomous software agent system 100 directly from conversations they are having with colleagues in the third-party messaging application. Furthermore, the autonomous software agent system 100 will reply directly in the messaging thread and anyone can jump into the thread and provide further instructions to the autonomous software agent system 100.

In some embodiments, the autonomous software agent system 100 integrated with a third-party messaging application further includes a centralized server. In particular, the autonomous software agent system 100 utilizes a centralized server that is responsible for forwarding information between the autonomous software agent system 100 and the third-party messaging application. To illustrate, a user of a computing device can install a messaging integration for the autonomous software agent system 100 into a messaging workspace and further add the integration to the relevant channels of a third-party messaging application.

In some embodiments, if the autonomous software agent system 100 receives a tag/mention of an autonomous software agent in the third-party messaging application, then the autonomous software agent system 100 utilizes a centralized server to recognize the tag/mention. Furthermore, the autonomous software agent system 100 passes that tag/mention along to a web server backend that a website hosted by the autonomous software agent system 100 uses to start a new session (e.g., initiate an autonomous software agent for deployment).

As further shown in FIG. 4 and as discussed above, the autonomous software agent system 100 further accesses/receives knowledge 404. In particular, the knowledge 404 can include a development environment, guidelines, code repositories, and/or one or more software tasks from the knowledge library discussed above. As shown in FIG. 4, the knowledge 404 can include knowledge items 404a (e.g., as discussed above). In some embodiments, the knowledge 404 can include a development environment, guidelines, code repositories, and a software task.

As further shown in FIG. 4, the autonomous software agent system 100 further performs an act 406 of deploying an autonomous software agent (e.g., a cloned virtual machine that is isolated and can perform tasks siloed from other devices). Moreover, as shown in FIG. 4, the autonomous software agent system 100 further provides to the autonomous software agent a shell tool 408, a browser tool 410, an integrated development environment 412 (e.g., an editor), and a planner tool 414.

In one or more embodiments, the autonomous software agent system 100 utilizes the planner tool 414 to generate an artificial intelligence plan in accordance with one or more embodiments. In particular, the autonomous software agent system 100 accesses/receives the prompt 402 (e.g., from a user computing device). Furthermore, the autonomous software agent system 100 deploys an autonomous software agent to operate within an independent virtual machine computing environment.

More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 414 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 414 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 414 is configured to decompose complex objectives into a sequence of actionable subtasks, determine dependencies and ordering among subtasks, and construct an execution plan consumable by downstream components such as code generation modules, debugging modules, the browser tool 210, the shell tool 208, IDE 212, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

In certain embodiments, planner tool 414 employs prompt-based reasoning, chain-of-thought inference, tree search, beam search, Monte Carlo sampling, reinforcement learning–based policy selection, or combinations thereof to evaluate multiple candidate plans and select or refine a plan according to defined optimization metrics. The planner tool 414 may further incorporate memory mechanisms, including contextual embeddings, vector databases, episodic execution logs, or persistent state representations, to inform plan generation based on prior interactions or historical outcomes. The planner tool 414 may monitor intermediate execution results and dynamically revise, re-order, expand, or prune subtasks based on feedback including compiler diagnostics, runtime errors, test failures, environmental changes, or external tool responses. In this manner, planner tool 414 supports iterative, adaptive, reactive, or predictive planning strategies. In some embodiments, the planner tool 414 operates as a distinct module that communicates with other components of autonomous software agent system 100 via structured messages, application programming interfaces (APIs), or message-passing protocols.

In one or more embodiments, the autonomous software agent system 100 utilizes the planner tool 414 to improve the efficiency and accuracy of executing a software task from the prompt 402. In some embodiments, the autonomous software agent system 100 utilizes the planner tool 414 to generate a running “to do” list. In particular, the autonomous software agent system 100 can use the planner tool 414 to break down the prompt 402 and to infer one or more intents of the prompt 402. In one or more embodiments, the autonomous software agent system 100 utilizes the planner tool 414 to assist a user computing device in visualizing how the autonomous software agent (e.g., deployed by the autonomous software agent system 100) plans and thinks through solving a problem (e.g., as indicated in the prompt 402).

In some embodiments, the autonomous software agent system 100 utilizes a large language model (e.g., a planning model) to analyze the prompt. In one or more embodiments, the autonomous software agent system 100 utilizes the large language model that leverages retrieval-augmented generation (RAG) to generate an artificial intelligence plan. In some embodiments, retrieval-augmented generation refers to retrieving relevant information from an external database or knowledge source in context of the prompt 402. In particular, the autonomous software agent system 100 can utilize RAG (e.g., which includes using the large language model) to generate a response (e.g., the artificial intelligence plan) by leveraging both the retrieved information (from an external source) and its own internal knowledge base. In particular, the autonomous software agent system 100 leverages RAG, which includes an input query, information retrieval, and response generation to perform a task of generating the artificial intelligence plan.

In some embodiments, the autonomous software agent system 100 further utilizes the large language model to perform an act of extracting a meta-task from the prompt 402. Moreover, as shown, the autonomous software agent system 100 performs an act of extracting intermediate tasks (e.g., sub-tasks) from the meta-task. In one or more embodiments, the autonomous software agent system 100 analyzes the prompt 402, determines an intent (e.g., a meta-task) of the prompt 402, and determines discrete sub-tasks (e.g., intermediate tasks).

In particular, the autonomous software agent system 100 can prompt the large language model to divide the prompt 402 into manageable and discrete sub-portions. In other words, the autonomous software agent system 100 prompts the large language model to identify tasks that point to different code repositories, data sources, and systems as being their own sub-task. In particular, the autonomous software agent system 100 can prompt the large language model and include example breakdowns of example requests.

Moreover, in some embodiments, the autonomous software agent system 100 trains the large language model with example datasets for breaking down a request into a meta-task and a plurality of sub-tasks. In particular, the autonomous software agent system 100 trains the large language model by having it generate a predicted artificial intelligence plan and then comparing the prediction to a ground truth reference.

In some embodiments, the autonomous software agent system 100 utilizes the large language model to generate an artificial intelligence plan to execute a software task. In particular, the autonomous software agent system 100 generates the artificial intelligence plan which includes a meta-task extracted from the prompt 402 and intermediate tasks extracted from the meta-task. In one or more embodiments, the autonomous software agent system 100 provides the artificial intelligence plan to a graphical user interface of a computing device. In particular, the autonomous software agent system 100 provides the artificial intelligence plan to receive approval or modification from a user computing device.

In one or more embodiments, the autonomous software agent system 100 supports multiple knowledge injection modes. For example, certain knowledge items may be designated as always-on knowledge that is injected into an autonomous software agent session at initialization of an independent virtual machine computing environment. Other knowledge items may be conditionally retrieved during generation of an artificial intelligence plan, during execution of a sub-task, or in response to dynamic context changes detected within the shell tool, browser tool, or integrated development environment. In some embodiments, the autonomous software agent system 100 differentiates between planner-phase knowledge, which influences task decomposition and meta-task generation, and execution-phase knowledge, which influences command generation, code writing, or navigation actions. Accordingly, knowledge may affect reasoning behavior, model selection, and tool orchestration in addition to customizing the development environment.

In one or more embodiments, knowledge items comprise structured operational constraints that influence the reasoning process of the autonomous software agent. For example, a knowledge item may encode policies such as mandatory linting checks, required security scanning procedures, restricted libraries, approved deployment workflows, or required test coverage thresholds. In some embodiments, the autonomous software agent system 100 injects such policy-based knowledge into planner prompts or system-level instructions provided to one or more large language models. In doing so, the autonomous software agent system 100 constrains generation of artificial intelligence outputs to comply with defined operational policies. Thus, knowledge may function not only as contextual reference material but also as enforceable behavioral constraints.

In one or more embodiments, the autonomous software agent system 100 can determine a relevance of a certain knowledge trigger (e.g., corresponding to a task/sub-task) based on the artificial intelligence plan. As discussed above in FIG. 3, the autonomous software agent system 100 utilizes RAG to determine a relevant knowledge trigger for the context of a sub-task. In some embodiments, the autonomous software agent system 100 extracts a meta-task and a plurality of sub-tasks from a software task indicated in the prompt 402. In doing so, the autonomous software agent system 100 can determine that a first sub-task triggers a first knowledge trigger (e.g., the first sub-task operates within a specific code repository that corresponds to the first knowledge trigger), a second sub-task triggers a second knowledge trigger (e.g., translating computer code to a different language), etc.

In other words, in some instances, the autonomous software agent system 100 can identify relevant knowledge triggers from the artificial intelligence plan generated by the autonomous software agent system 100 via the planner tool 414. In some embodiments, the autonomous software agent system 100 can identify relevant knowledge triggers after an artificial intelligence plan is being executed by an autonomous software agent. In particular, the autonomous software agent system 100 detects a relevant knowledge trigger as it begins to get into the details of executing a software sub-task and provides relevant knowledge items to execute that software sub-task. On the other hand, in some embodiments, the autonomous software agent system 100 identifies relevant knowledge triggers during the course of generating the artificial intelligence plan (e.g., prior to the autonomous software agent executing a task/sub-task).

In some embodiments, the autonomous software agent system 100 can receive modifications to one or more tasks/sub-tasks and/or the meta-task extracted from the prompt 402. In some instances, the autonomous software agent system 100 can receive additional context or additional files to further customize the artificial intelligence plan. In some embodiments, the autonomous software agent system 100 receives one or more modifications to the artificial intelligence plan and generates a modified artificial intelligence plan.

Further, the autonomous software agent system 100 can prompt a user of a computing device to provide approval of the modified artificial intelligence plan. In response to receiving approval of an (updated) artificial intelligence plan, the autonomous software agent system 100 deploys the autonomous software agent to execute the prompt 402 according to the artificial intelligence plan.

Accordingly, in some embodiments, the autonomous software agent system 100 can modify its determination of relevant knowledge triggers based on one or more user inputs. In particular, the autonomous software agent system 100 can receive modifications to an artificial intelligence plan, and in response, detect additional relevant knowledge triggers or reverse previously detected knowledge triggers (e.g., as irrelevant knowledge triggers).

In some embodiments, the autonomous software agent system 100 utilizes the browser tool 410 to perform one or more actions responsive to prompt 402 to execute a software task. For example, the autonomous software agent system 100 accesses/receives the prompt 402. In one or more embodiments, the autonomous software agent system 100 utilizes the browser tool 410 to browse documentation on one or more website domain pages, test web applications (e.g., local applications), download information, upload information, etc. In particular, the autonomous software agent system 100 utilizes the browser tool 410 to perform a first navigation step, a second navigation step, and a third navigation step on a website page.

In one or more embodiments, a website page (e.g., a website domain page) refers to a webpage hosted under a domain name that serves as an entry point of a website and is identified by a URL. For example, a website page refers to a digital webpage associated with a domain name that has a unique URL and contains structured content (e.g., text, images, links, and other media). In particular, a website page is part of a larger website hierarchy. To illustrate, a website hierarchy includes a homepage, subpages, and subdomain pages. In some embodiments, a plurality of website domain pages is associated with an entity.

In one or more embodiments, the autonomous software agent system 100 utilizes the browser tool 410 to obtain information from a website page. In some embodiments, the autonomous software agent system 100 determines whether a particular portion of a website page is relevant to the prompt 402 to execute a software task. In particular, the autonomous software agent system 100 utilizes a large language model (e.g., a website relevance model) to determine the relevance of a sub-portion, portion, or entire website page.

In other words, website pages contain an excessive amount of information. In particular, large language models are typically bogged down with processing all elements within a website page. Thus, the autonomous software agent system 100 distills a website page structure (e.g., utilizing the large language model) and provides a simplified structure (e.g., HTML) to the autonomous software agent for further processing. In doing so, the autonomous software agent system 100 enables the autonomous software agent to process a large amount of data from website pages without performance degradation.

In some embodiments, the autonomous software agent system 100 utilizes the large language model to perform an act of determining a document object model (DOM) of a website page. In particular, the autonomous software agent system 100 passes a website page to the large language model to determine a document object model of the website page.

In one or more embodiments, a document object model refers to a structured, hierarchical representation of a webpage’s content that defines how HTML elements are programmatically accessed, modified, and analyzed. In one or more embodiments, the autonomous software agent system 100 detects a document object model object within a website page. For example, the DOM includes a representation of structure, content and properties within a website page. For instance, a user of a website page interacts with and manipulates a DOM object. Further, in some embodiments the DOM includes HTML or XML format. Accordingly, the DOM includes references to specific elements or nodes within the website page. To illustrate, DOM objects are part of a DOM tree structure, where each node of the DOM tree structure corresponds to a specific element in a website page.

In some embodiments, the autonomous software agent system 100 utilizes the large language model to perform an act of identifying relevant document object model elements (e.g., DOM elements). In particular, the autonomous software agent system 100 prompts the large language model to identify relevant DOM elements in context of the prompt 402. In other words, the autonomous software agent system 100 utilizes the large language model to distill a website page into a relevant set of elements for the prompt 402.

In some embodiments, the autonomous software agent system 100 utilizes the large language model to generate a simplified DOM tree (e.g., a simplified document object model tree). As mentioned above, in some instances, a website page contains a large amount of data that can potentially bog down computational processes. As such, the autonomous software agent system 100 utilizes the large language model to extract the most salient/relevant elements from a website page (e.g., being browsed via the browser tool 410) and generates the simplified DOM tree.

In one or more embodiments, the simplified DOM tree refers to distilled document object model structure and/or a distilled hierarchical representation of a webpage’s content. In particular, the simplified DOM tree includes a hierarchy of nodes and elements from the website page that are relevant to the prompt 402. In other words, the simplified DOM tree contains fewer website page elements relative to an initially determined DOM tree from the website page.

In one or more embodiments, the autonomous software agent system 100 can utilize the simplified DOM tree as contextual data of a website page and determine whether there is a relevant knowledge trigger in the knowledge library. For example, as discussed above, the autonomous software agent system 100 can detect relevant knowledge triggers by transmitting contextual data and a large language model relevance prompt to a large language model. In particular, the autonomous software agent system 100 can transmit the simplified DOM tree (e.g., which captures relevant elements) and a prompt to a large language model to determine whether there are any relevant knowledge triggers.

In some embodiments, the autonomous software agent system 100 utilizes the shell tool 408 to generate one or more terminal commands. In one or more embodiments, the shell tool 408 (or simply shell) refers to one or more terminals (e.g., one or more terminal windows). In particular, the autonomous software agent system 100 deploys the autonomous software agent that can create new terminal windows or switch to different terminal windows, or delete terminals (e.g., which is how an autonomous software agent can run multiple processes at once). For relatively long commands, the autonomous software agent system 100 can use the autonomous software agent to shift its attention away from the long-running command and multitask in parallel (e.g., via the shell tool 408).

In some embodiments, the shell tool 408 is a text-based application where the autonomous software agent can input commands that interact directly with a computer’s operating system. In particular, the autonomous software agent system 100 spins up the autonomous software agent that includes a shell application and in the shell application there are different terminals. As mentioned, where each terminal is like a single terminal window, the autonomous software agent system 100 (e.g., via the autonomous software agent) has the ability to create new terminals, switch to different terminal windows or delete terminals.

For example, a shell tool 408 refers to an interface layer that mediates interaction between an artificial intelligence (AI) agent and an underlying execution environment, computing system, development environment, or virtualized runtime. The shell tool 408 provides a structured command, control, and input/output framework through which the autonomous software agent system 100 issues instructions, receives responses, and orchestrates software development operations. A shell tool 408 may comprise a command-line interpreter, application programming interface (API) interface, remote procedure call (RPC) interface, messaging interface, terminal emulator, container interface, virtual machine interface, or any combination thereof. The shell tool 408 abstracts underlying system resources—including file systems, process control, compilers, interpreters, debuggers, network interfaces, and package managers—and presents a controllable operational surface to the autonomous software agent system 100.

Furthermore, the autonomous software agent system 100 performs an act of utilizing the autonomous software agent to generate terminal commands. In one or more embodiments, a terminal command refers to text instructions to instruct a computer’s operating system. In particular, a terminal command refers to one-line instructions that typically call upon existing programs of an operating system.

In some embodiments, a terminal command refers to text-based instructions submitted/inputted into a terminal (e.g., the terminal is an interface that allows computing devices such as the autonomous software agent to interact with a computer system’s underlying operating system or run scripts and programs directly). To illustrate, terminal commands can include file and directory navigation, file operations, viewing file contents, searching and filtering, processes and systems in an operating system, determining permissions and ownerships in an operating system, and networking.

Moreover, the autonomous software agent system 100 generates command outputs. In one or more embodiments, command outputs refer to outputs that correspond with terminal commands submitted via the shell tool 408. To illustrate, a command output can include an absolute path (e.g., in response to a command to determine a location), tabular text (e.g., in response to a command to list files), raw file text (e.g., in response to a command to print file contents), an interactive viewer (e.g., in response to a command to provide a paged output), an output pattern (e.g., in response to a command to search/filter files in an operating system), and a file path (e.g., in response to a command to locate files).

Accordingly, the autonomous software agent system 100 utilizes the autonomous software agent to execute a software task (e.g., indicated by the prompt 402) by using the shell tool 408. In particular, the autonomous software agent system 100 determines a plurality of sub-tasks for a meta-task indicated in the prompt 402, generates an artificial intelligence plan, and utilizes the shell tool to execute one or more of the sub-tasks (e.g., by submitting terminal commands).

In some embodiments, the autonomous software agent system 100 receives a selection of a shell feature and opens/launches an interactive shell of the autonomous software agent. In particular, the autonomous software agent system 100 causes a graphical user interface (e.g., of a user computing device) to show shell activity (e.g., terminal commands or outputs corresponding to terminal commands) of the autonomous software agent utilizing the shell tool 408 while independently performing the software task. Accordingly, the user computing device (e.g., via the graphical user interface) can intervene (e.g., take over) the autonomous software agent’s shell and push a software task in a different direction.

In one or more embodiments, the autonomous software agent system 100 determines a relevant knowledge trigger based on terminal commands or terminal command outputs. In particular, the autonomous software agent system 100 utilizes an autonomous software agent to execute a sub-task by submitting terminal commands/generating terminal command outputs and determines a relevant knowledge trigger. In particular, the autonomous software agent system 100 transmits contextual data of the shell tool 408 and a large language model relevance prompt to a large language model to determine whether there is a relevant knowledge trigger for the current sub-task.

Moreover, in some embodiments, the autonomous software agent system 100 determines a relevant knowledge trigger based on a user computing device intervening within the shell tool 408. In other words, a user computing device may push a software task in a different direction, and in response, the autonomous software agent system 100 determines a relevant knowledge trigger from the knowledge library.

In one or more embodiments, the autonomous software agent system 100 utilizes the integrated development environment 412 to generate computer code in accordance with one or more embodiments. For example, the autonomous software agent system 100 accesses/receives a request and deploys an autonomous software agent. In particular, the autonomous software agent system 100 deploys the autonomous software agent to operate within an independent virtual machine computing environment.

Moreover, the autonomous software agent system 100 provides the integrated development environment 412 (IDE tool) to the autonomous software agent. In one or more embodiments, the integrated development environment 412 of the autonomous software agent includes an editor (e.g., in some embodiments, the autonomous software agent utilizes multiple editor tabs which represent open files in an editor area of the IDE for writing/editing computer code). In particular, the editor corresponds to an open file.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task.

In some embodiments, the autonomous software agent system 100 utilizes the integrated development environment 412 to perform an act of generating computer code. In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. In some embodiments, function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

In some embodiments, test code refers to computer code that defines a function test for function code. For example, test code can include one or more code segments for determining that the function code satisfies an intent query. In some cases, the autonomous software agent system 100 utilizes test code to test function code. For example, the autonomous software agent system 100 generates the test code that includes computer code for testing whether the output of function code satisfies an intent query. In some embodiments, test code can also test for different types of errors (e.g., syntax errors and logic errors) and/or for hazardous or harmful function code.

In some embodiments, the computer code includes executable program code which refers to a set of instructions that a computing device can directly execute. In particular, executable program code includes machine-readable instructions that result from compiling high-level programming languages. In other words, executable program code refers to a final output for a software development process created by compiling source code.

As noted above, in one or more embodiments, the autonomous software agent system 100 provides actions performed by the autonomous software agent to a graphical user interface of a user (e.g., a user computing device). In particular, in context of the integrated development environment 412, the autonomous software agent system 100 can provide to a graphical user interface real-time actions and/or actions performed during a development session of the autonomous software agent utilizing the integrated development environment 412.

In some embodiments, the autonomous software agent system 100 can receive an input selection that relates to a user computing device indicating a desire to modify one or more inputs in the integrated development environment 412. Further, in some embodiments, the autonomous software agent system 100 can receive an input selection to follow the autonomous software agent (e.g., in real-time) as the autonomous software agent executes a software task indicated by the prompt 402.

In some embodiments, the autonomous software agent system 100 provides for display the integrated development environment 412 that includes the above-mentioned editor tab. Further, in some instances, the autonomous software agent system 100 also provides a problems tab which lists errors, warnings, and information for computer code (in the editor tab) for a user to efficiently see errors in computer code or jump to problematic portions of computer code), an output tab (e.g., shows logs and messages from the IDE or extensions of the IDE to be notified of background activities like loading data onto a server or plugin operations), a debug console (e.g., allows for interactions with a program during debugging, such as viewing runtime logs, evaluating expressions, or inspecting variables), a terminal (e.g., a built-in shell/command-line interface for executing/submitting commands to a terminal, such as running scripts or installing packages), and a version control tab (e.g., provides information as to which devices submitted changes to a code repository and why the changes were submitted to a code repository).

In one or more embodiments, the autonomous software agent system 100 detects a relevant knowledge trigger as the autonomous software agent is utilizing the integrated development environment 412. In particular, the autonomous software agent system 100 transmits contextual data of the integrated development environment 412 and a large language model relevance prompt to a large language model to determine a relevant knowledge trigger (if any).

In some embodiments, as the autonomous software agent writes computer code in the integrated development environment 412, the autonomous software agent determines that specific knowledge is required to continue executing the software task. However, after transmitting the context and a large language model prompt to a large language model, the autonomous software agent system 100 determines there are no relevant knowledge triggers in the knowledge library. In such cases, the autonomous software agent system 100 directly prompts a user computing device to provide the relevant knowledge (e.g., knowledge items). Moreover, in some embodiments, the autonomous software agent system 100 also prompts the user computing device to save the relevant knowledge in the knowledge library.

Additionally, FIG. 4 shows the autonomous software agent system 100 utilizing the autonomous software agent to generate artificial intelligence output(s) 416. In particular, the autonomous software agent system 100 deploys the autonomous software agent to execute the prompt 402 and generate the artificial intelligence output(s) responsive to the prompt 402.

Indeed, in one or more embodiments, the autonomous software agent system 100 is configured to automatically (e.g., without further user instructions other than the prompt defining the software task) perform an assigned software task using coordinated interaction among planner tool 414, browser tool 410, an integrated development environment (IDE) 412, a shell tool 408, and an independent virtual machine computing environment. For example, upon receiving a software task—expressed in natural language, structured specification, source code fragment, test case, or other machine-interpretable format—the autonomous software agent system 100 provides the software task to planner tool 414. The planner tool 414 analyzes the objective and generates a structured execution plan comprising an ordered set of subtasks, dependency relationships, required tools, expected outputs, and validation criteria. The execution plan may define actions such as retrieving documentation, generating source code, creating files, compiling code, executing tests, debugging failures, refactoring modules, or deploying artifacts. The autonomous software agent system 100 executes the structured plan within the independent virtual machine computing environment. Where plan steps require external information or dependency retrieval, the autonomous software agent system 100 invokes the browser tool 410 within the independent virtual machine computing environment. The autonomous software agent system 100 uses the browser tool 410 to retrieve and parse remote documentation, knowledge, API specifications, repositories, or other network-accessible resources and returns structured, machine-readable representations to autonomous software agent system 100 for reasoning and code synthesis.

For code authoring and modification operations, the autonomous software agent system 100 interacts with the IDE 412. The IDE 412 enables creation, editing, refactoring, and organization of source files, as well as invocation of compilers, interpreters, build systems, static analysis tools, and test frameworks. The IDE 412 provides structured diagnostics, including syntax errors, semantic warnings, dependency conflicts, and build logs, which are returned to autonomous software agent system 100. Where system-level commands are required, autonomous software agent system 100 issues instructions through the shell tool 408 executing within the independent virtual machine computing environment. The shell tool 408 enables file system manipulation, dependency installation, build execution, test invocation, process control, and other operating system–level operations. Structured outputs including exit codes, logs, and error streams are returned to autonomous software agent system 100.

The planner tool 414, in one or more implementations, monitors intermediate results generated by the IDE 412, browser tool 410, and shell tool 408, and compares those results against plan-defined success criteria. If discrepancies, failures, or unexpected states are detected, the planner tool 414 automatically revises the execution plan, generates corrective subtasks, reorders actions, or initiates debugging procedures. This iterative loop continues until the software task satisfies defined completion conditions or termination criteria. In this manner, autonomous software agent system 100 autonomously decomposes, executes, validates, and refines development actions within the independent virtual machine computing environment using coordinated tool invocation and structured feedback processing. The integration of planner tool 414, browser tool 410, the IDE 418, the shell tool 408, and the independent virtual machine computing environment enables end-to-end automated software development, testing, and validation without direct human intervention.

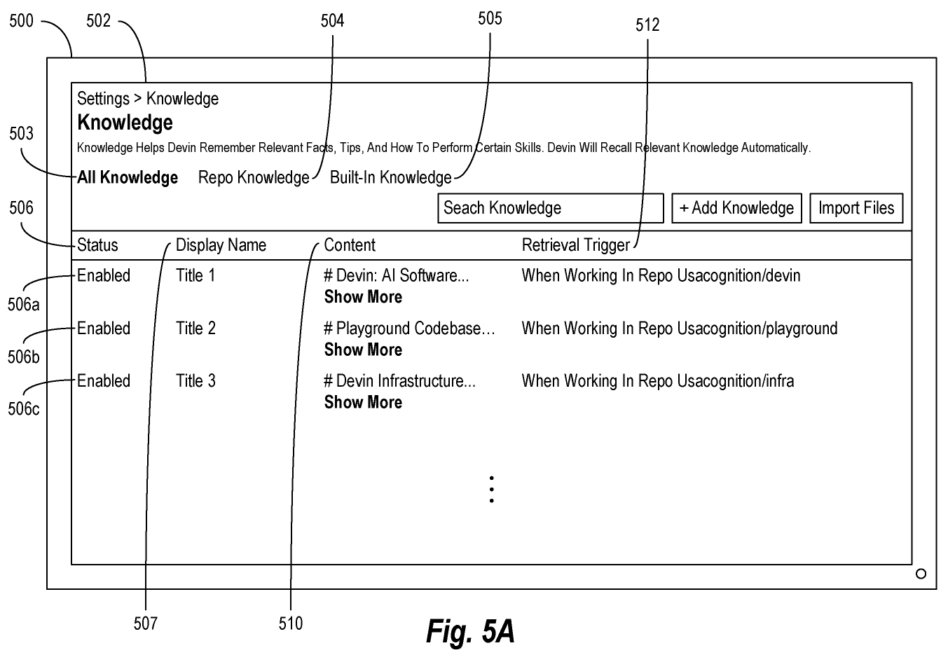

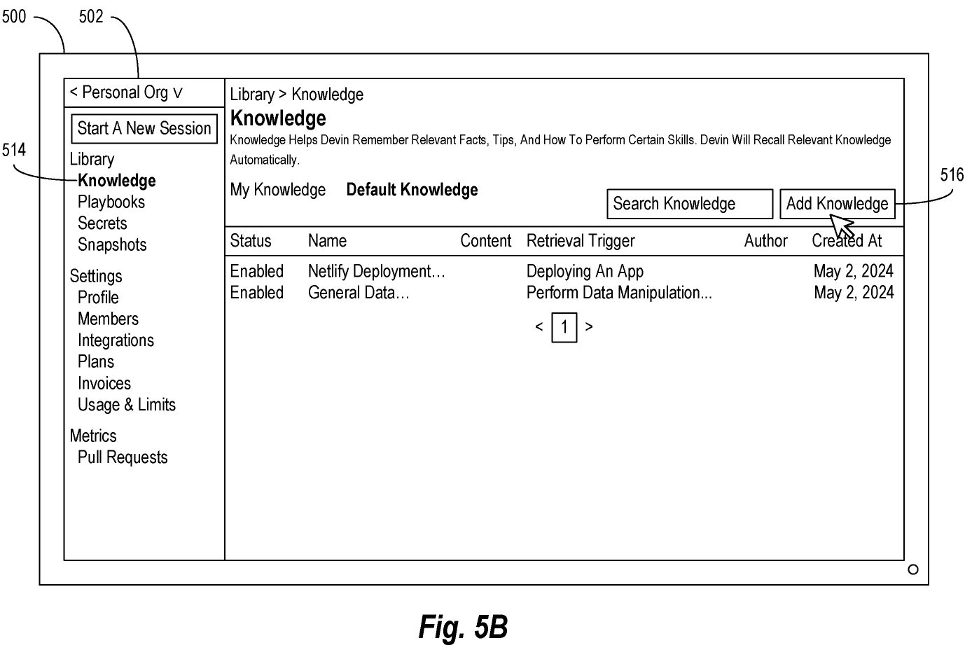

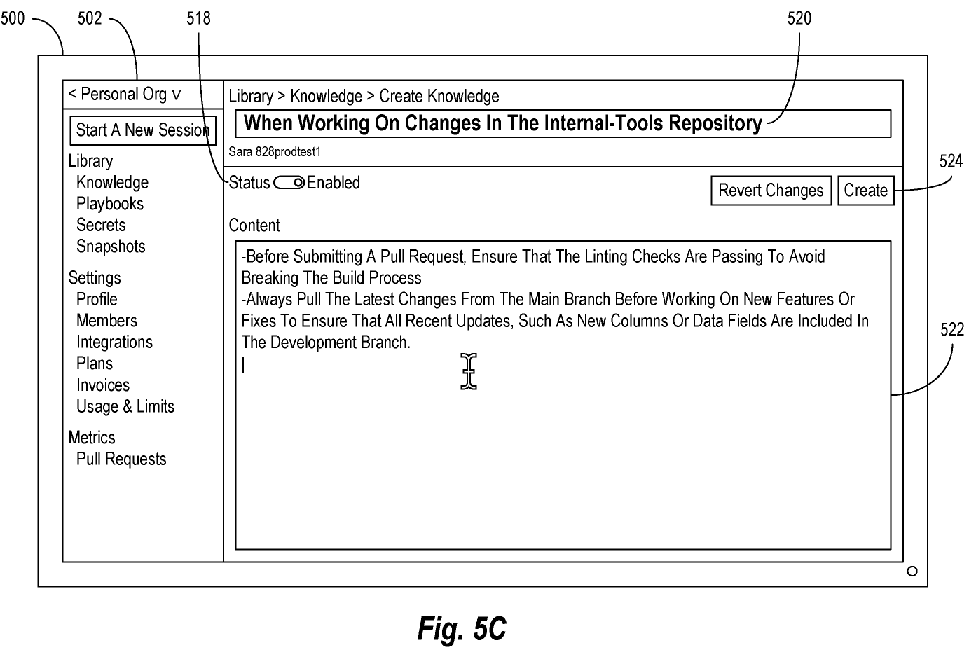

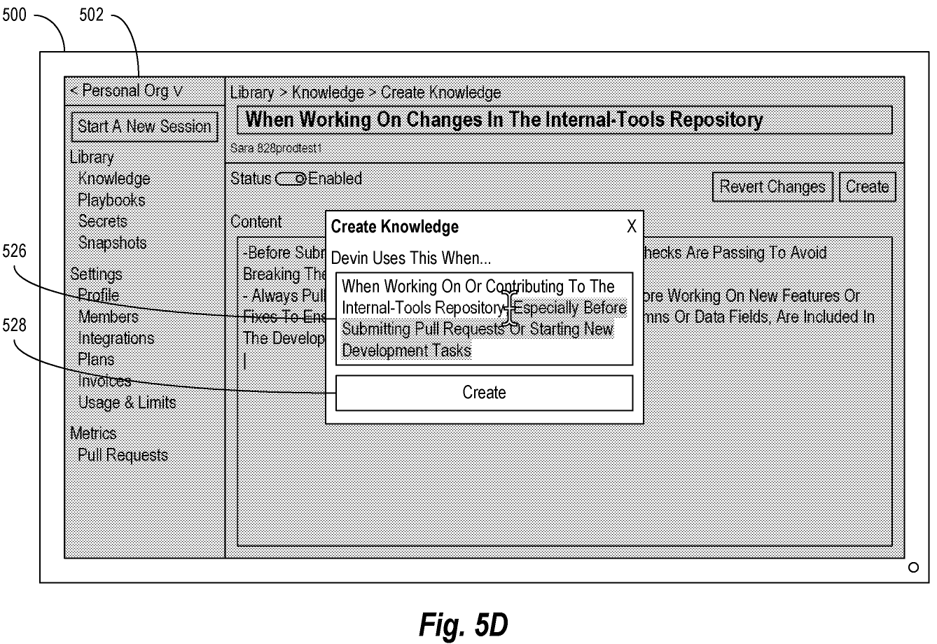

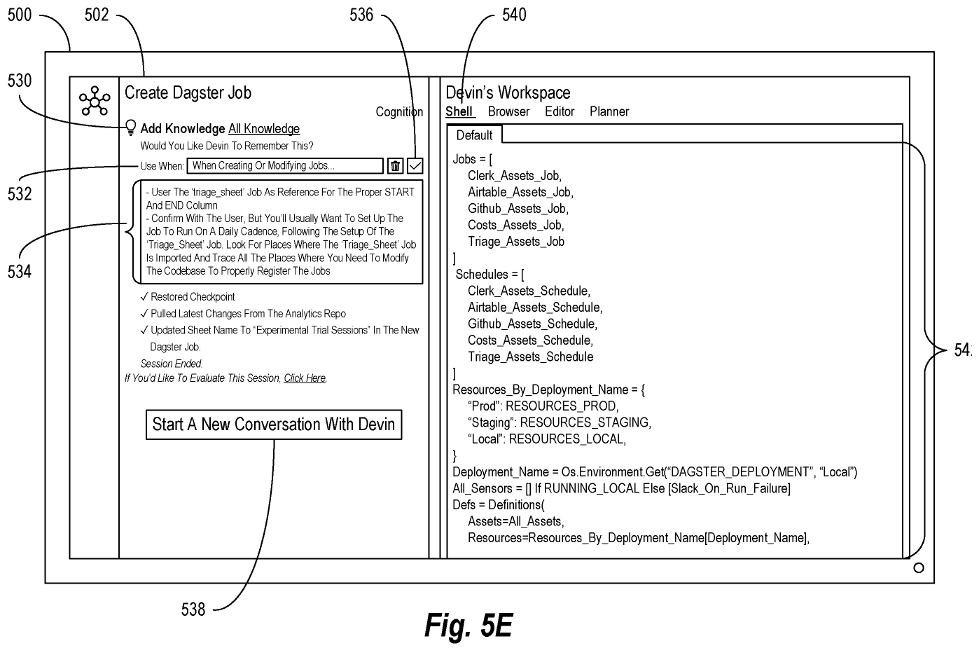

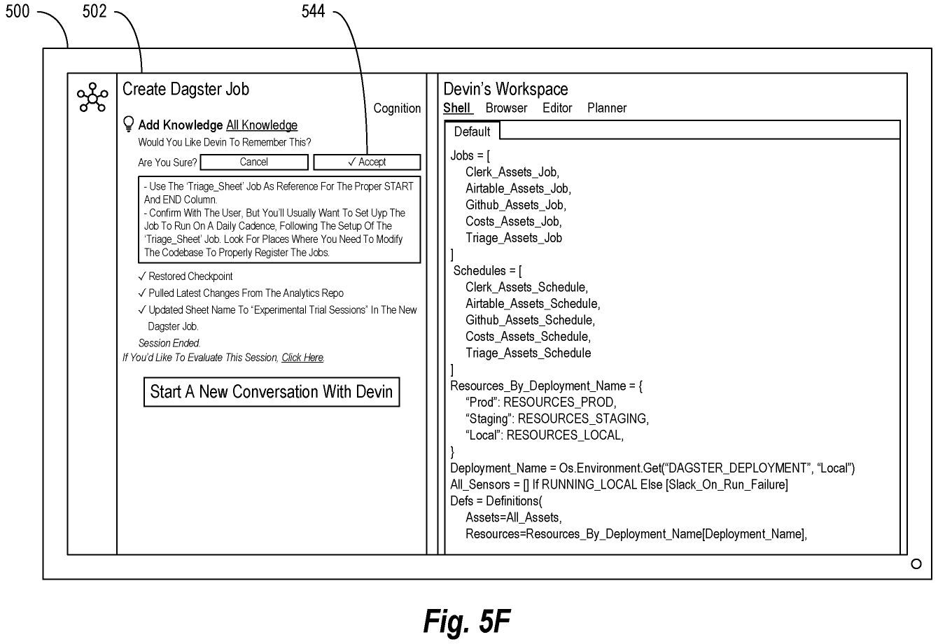

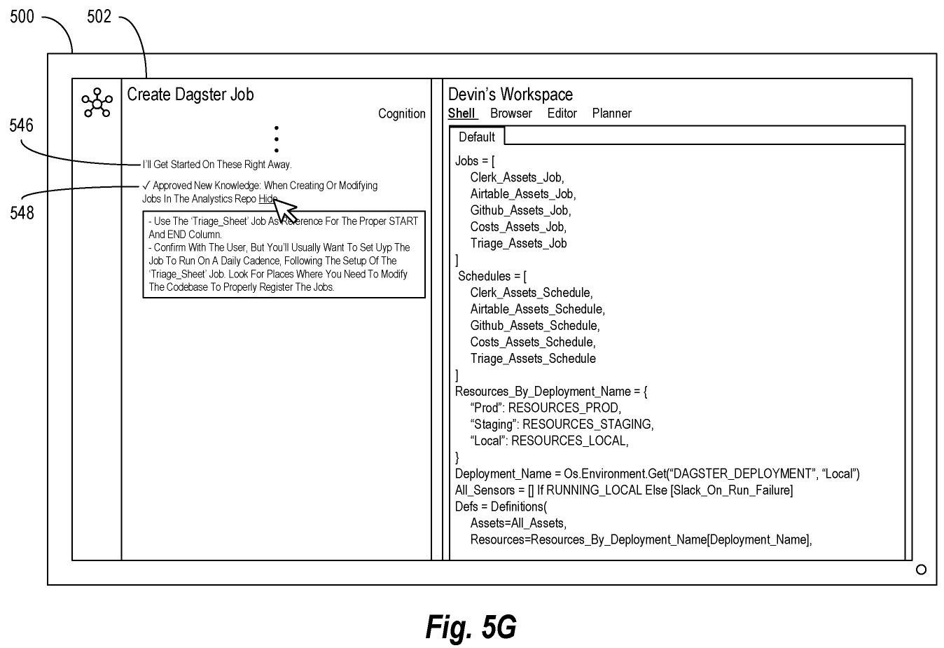

FIG. 5A shows the autonomous software agent system 100 providing a knowledge interface in accordance with one or more embodiments. For example, FIG. 5A shows a graphical user interface 502 of a user computing device 500 displaying a knowledge interface for configuring an autonomous software agent to remember relevant facts, tips, and how to perform certain skills. As mentioned above, the autonomous software agent system 100 causes an autonomous software agent to automatically recall relevant knowledges (e.g., knowledge) based on knowledge triggers.

FIG. 5A shows a first tab 503 (e.g., all knowledge), a second tab 504 (e.g., repository knowledge), and a third tab 505 (e.g., built-in knowledge). In some embodiments, the second tab 504 refers to a view of the knowledge interface that shows knowledges relating to connected code repositories. Further, in some embodiments, the third tab 505 refers to a view of the knowledge interface that shows knowledges relating to skills, documentation, contextual tips, etc. for executing various software tasks.

In one or more embodiments, the knowledge library supports collaborative editing within a workspace or organization. For example, a first user may create a knowledge item, and a second user may edit, comment on, or propose modifications to the knowledge item. In some embodiments, the autonomous software agent system 100 maintains author metadata and tracks contributions from multiple users. In some embodiments, administrative users may approve or reject proposed knowledge modifications before activation. Accordingly, the knowledge library may operate as a collaborative policy management system for software development teams.

FIG. 5A shows a selection of the first tab 503 in the graphical user interface 502. For example, FIG. 5A shows a status column 506, a display name column 507, a content column 510, and a retrieval trigger column 512. In particular, FIG. 5A shows a first status 506a, a second status 506b, and a third status 506c as being enabled. In other words, the knowledge or knowledge is active and will be recalled when the autonomous software agent system 100 encounters a relevant knowledge trigger.

In one or more embodiments, the autonomous software agent system 100 provides a searchable and filterable knowledge interface. For example, a user computing device may filter knowledge items by scope, repository, status, creation date, author, or trigger type. In some embodiments, the knowledge interface supports full-text search over knowledge details and memory triggers. The autonomous software agent system 100 may further display diagnostic indicators showing whether a knowledge item was recently used, frequently triggered, or currently inactive.

Furthermore, FIG. 5A shows that the display name column 507 includes a first title, a second title, and a third title with corresponding first content, second content, and third content. Moreover, FIG. 5A shows that the retrieval trigger column 512 further includes specific contexts in which the knowledge is recalled. To illustrate, the retrieval trigger column 512 can include triggers such as “when working in repo X/usa/Devin,” “when working in repo Y/usa/Devin/playground,” and “when tasked with converting or translating SA5 code into Python code.”

FIG. 5B shows the autonomous software agent system 100 showing the knowledge interface in accordance with one or more embodiments. For example, FIG. 5B shows a selection of a knowledge tab 514, where the knowledge interface shows two knowledges that are both enabled. In particular, FIG. 5B shows a name of deployment workflow and general data science workflow with corresponding retrieval triggers of deploying an app and performing a data manipulation. Additionally, FIG. 5B shows an add knowledge element 516.

In some embodiments, in response to a selection of the add knowledge element 516, the autonomous software agent system 100 transitions the graphical user interface 502 to display the interface shown in FIG. 5C. For example, FIG. 5C shows a title input element 520. In particular, the title input element 520 allows the user computing device 500 to customize the name of a knowledge. To illustrate, FIG. 5C shows the title as “when working on change in the internal-tools repository.”

Furthermore, FIG. 5C shows a status 518 of the knowledge. In particular, the status 518 indicates whether knowledge is active. As shown in FIG. 5C the status 518 is enabled. Moreover, FIG. 5C shows knowledge detail input 522. In particular, the knowledge detail input 522 allows the user computing device 500 to provide guidance/instructions and/or content to the autonomous software agent system 100. To illustrate, FIG. 5C shows the knowledge detail input 522 as “before submitting a pull request, ensure that the linting checks are passing to avoid breaking the build process; always pull the latest changes from the main branch before working on new features or fixes to ensure that all recent updates, such as new columns or data fields are included in the development branch.” Additionally, FIG. 5C shows a create element 524. In response to a selection of the create element 524, the autonomous software agent system 100 generates and stores the knowledge shown in FIG. 5C within a knowledge library.

In one or more embodiments, the knowledge library 300 maintains version histories of knowledge items. For example, when a knowledge item is modified, the autonomous software agent system 100 stores a prior version and associates timestamp metadata, author metadata, and revision identifiers with the updated knowledge item. In some embodiments, the autonomous software agent system 100 allows a user computing device to revert a knowledge item to a previous version or to deactivate deprecated knowledge items. Additionally, in some embodiments, knowledge items include lifecycle states such as draft, active, inactive, archived, or deprecated. The autonomous software agent system 100 may exclude inactive or deprecated knowledge items from retrieval operations unless explicitly requested. Accordingly, the knowledge library may function as a version-controlled repository of operational policies and development guidance.

FIG. 5D shows the autonomous software agent system 100 providing an option for the user computing device 500 to configure a knowledge trigger in accordance with one or more embodiments. For example, FIG. 5D shows a knowledge trigger input element 526. In particular, the autonomous software agent system 100 provides the knowledge trigger input element 526 to the user computing device 500 for a user to specify the context of when a knowledge should be recalled.

To illustrate, FIG. 5D shows the knowledge trigger input element 526 reads “when working on or contributing to the internal-tools repository, especially before submitting pull requests or starting new development tasks,” as the knowledge trigger. Furthermore, FIG. 5D shows the user computing device 500 highlighting the second half of the knowledge trigger (e.g., for deletion or modification). Additionally, FIG. 5D shows a creation option element 528. In response to a selection of the creation option element 528, the autonomous software agent system 100 creates the knowledge with the knowledge trigger shown in FIG. 5D.

FIG. 5E shows the autonomous software agent system 100 prompting the user computing device 500 to save an input as knowledge in a knowledge library in accordance with one or more embodiments. For example, FIG. 5E shows the autonomous software agent system 100 providing for display a prompt 530 which reads “would you like Devin to remember this?” In particular, as the autonomous software agent system 100 executes a software task, the autonomous software agent can encounter a task that requires guidance/instructions from the user computing device 500. In particular, the autonomous software agent system 100 receives guidance/instructions from the user computing device 500 and determines that the guidance/instructions may be relevant for future development sessions.

As shown in FIG. 5E, the autonomous software agent system 100 generates a knowledge trigger 532 (e.g., when creating or modifying jobs in the analysis database), knowledge items 534 (e.g., use the ‘triage_sheet’ job as reference for the proper START and END column; confirm with the user, but you’ll usually want to set up the job to run on a daily cadence, following the setup of the ‘triage_sheet’ job. Look for places where the ‘triage_sheet’ job is imported and trace all the places where you need to modify the codebase to properly register the jobs).

Additionally, FIG. 5E shows a confirmation option element 536. In response to a selection of the confirmation option element 536, the autonomous software agent system 100 can save the knowledge trigger 532. Furthermore, FIG. 5E shows a shell interface 540. In particular, the shell interface 540 displays terminal commands 542 submitted by the autonomous software agent executing a software task. Moreover, FIG. 5E shows a start new conversation element 538 for the user computing device 500 to engage in additional rounds of conversation with the autonomous software agent system 100.

In one or more embodiments, the autonomous software agent system 100 can generate a knowledge suggestion based on feedback received from the user computing device 500. In particular, rather than having the user computing device 500 manually edit an existing knowledge within the knowledge library, the autonomous software agent system 100 can provide artificial intelligence suggestions to create a new knowledge based on an existing knowledge. For example, the autonomous software agent system 100 can generate the artificial intelligence suggestions containing the new knowledge and prompt the user computing device 500 to save the new knowledge to the knowledge library. Additionally, in some embodiments, the autonomous software agent system 100 can also generate artificial intelligence suggestions for the user computing device 500 to update existing knowledge items (e.g., knowledge items) in addition to suggesting new knowledge items.

In one or more embodiments, the autonomous software agent system 100 analyzes repeated user-provided guidance across development sessions to identify candidate knowledge items for suggestion. For example, when similar instructions are provided multiple times across sessions, the autonomous software agent system 100 may generate a knowledge suggestion with an associated confidence score based on similarity metrics, embedding distance thresholds, or frequency heuristics. In some embodiments, knowledge items are ranked for retrieval based on historical usage frequency, relevance scores generated by a large language model, or similarity between a sub-task embedding and stored memory trigger embeddings. Accordingly, the autonomous software agent system 100 may prioritize certain knowledge items over others when multiple items exceed a relevance threshold.

FIG. 5F shows the autonomous software agent system 100 further prompting the user with an additional confirmation option element 544. In particular, in response to a selection of the additional confirmation option element 544, the autonomous software agent system 100 stores the knowledge shown in FIG. 5F in a knowledge library for future recall in future development sessions. FIG. 5G shows the autonomous software agent system 100 providing for display various steps of a development session to the graphical user interface 502. In particular, FIG. 5G shows a first development step 546 and a second development step 548. In particular, the first development step 546 relates to the autonomous software agent system 100 utilizing an autonomous software agent to perform one or more updates pertaining to a sub-task.

Moreover, as discussed above, the autonomous software agent system 100 prompts the user computing device 500 to save a knowledge. As shown in FIG. 5G, in response to the user computing device 500 approving the knowledge to be saved for future development sessions, the autonomous software agent system 100 provides the second development step 548 (e.g., approved new knowledge: when creating or modifying jobs in the analytics repo).

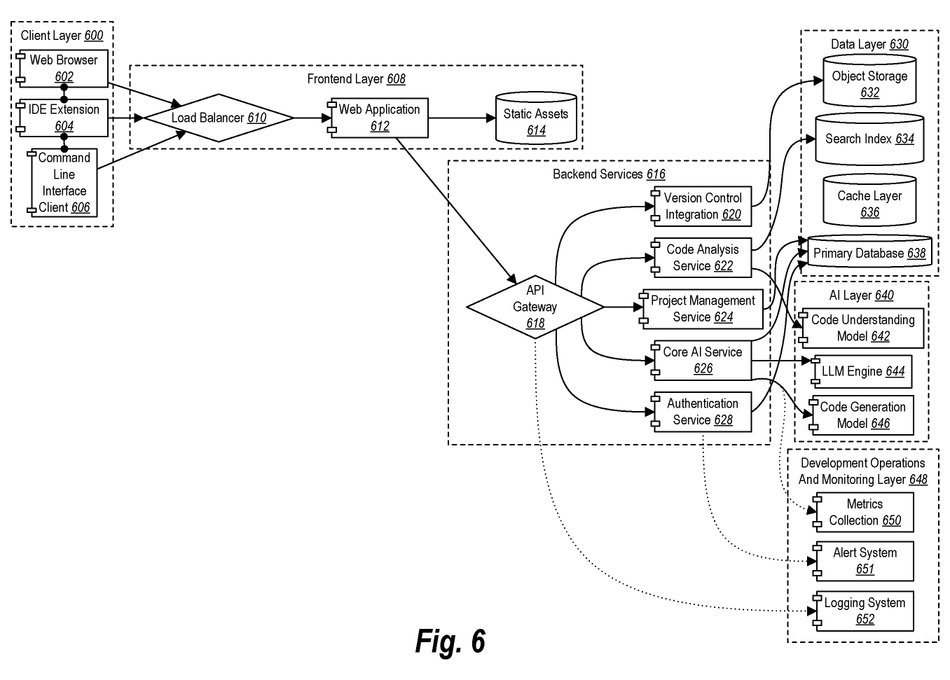

FIG. 6 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 6, the autonomous software agent system 100 contains a client layer 600 (e.g., with a web browser 602, an IDE extension 604, and a command line interface client 606), a frontend layer 608 with a load balancer 610 (e.g., which is a system to distribute incoming traffic across multiple servers which optimizes efficiency), a web application 612 (e.g., a Devin web application that shows a chat interface and the fully featured software composition tools of the autonomous software agent), and static assets 614 (e.g., files that do not dynamically change based on user interactions, such as HTML files, CSS files, JavaScript files, images, etc.).

Moreover, FIG. 6 shows the autonomous software agent system 100 also contains backend services 616 with an API gateway 618 (e.g., which is a single entry point for managing and routing API requests from client devices to different microservices/backend systems), a version control integration 620 (e.g., a backend service application to track changes to code such as a connected code repository application part of a code repository management system), a code analysis service 622, a project management service 624 (e.g., a software system to track the development of various tasks that a software development team is working on), a core AI service 626 (e.g., artificial intelligence modules or tools to handle the use of machine learning models, natural language processing, and other artificial intelligence tasks), and an authentication service 628 (e.g., to check for valid authentication credentials).

In particular, the backend services 616 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, providing a plurality of interactive tools to a user computing device. In particular, the backend services 616 of the autonomous software agent system 100 manage the generation of artificial intelligence outputs for executing a software task of a development session.

For example, the backend services 616 perform the job of enabling request decomposition, artificial intelligence plan generation, terminal command generation, computer code generation, navigation actions, software task orchestration, and interactive tools of the autonomous software agent. In particular, the client layer 600, the frontend layer 608 and the backend services 616 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 6 shows a data layer 630 with object storage 632 (e.g., which is storage of unstructured data), a search index 634 (e.g., an index of one or more code repositories), a cache layer 636 (e.g., a layer that temporarily holds frequently accessed or recently computed data), and a primary database 638 (e.g., a central data store to hold application data). Moreover, FIG. 6 shows an AI layer 640 with a code understanding model 642, an LLM engine 644, and a code generation model 646. Moreover, FIG. 6 shows a development operations and monitoring layer 648 (e.g., with metrics collection 650, an alert system 651, and a logging system 652).

As shown in FIG. 6, the autonomous software agent system 100 utilizes the AI layer 640 to perform a variety of reasoning/generation tasks. In particular, the autonomous software agent system 100 accesses the AI layer 640 every time a code repository is connected or updated, or a new session is spun up (e.g., each time a new development box is activated). In order to enable the AI layer 640, the autonomous software agent system 100 provides various onboarding tools to a user computing device. In particular, the onboarding tools allow a user to provide access to a code repository provider (e.g., a Gitprovider), select repositories, assign read access, and assign write access.

In some embodiments, the autonomous software agent system 100 prompts a user computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 6, the AI layer 640 of the autonomous software agent system 100 further includes the code understanding model 642. In particular, the code understanding model 642 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 642. To illustrate, the autonomous software agent system 100 parses through a code repository and generates abstraction summaries using the code understanding model 642 and one or more additional artificial intelligence models (e.g., such as the LLM engine).

Moreover, the autonomous software agent system 100 utilizes the AI layer 640 to enable AI-native features in a planner interface, a chat interface, or a configuration interface of an autonomous software agent. In particular, the autonomous software agent system 100 provides the AI-native features as options for a user computing device to activate during configuration or during interaction with the autonomous software agent system 100.

In some embodiments, the autonomous software agent system 100 uses the AI layer 640 to ingest data from a code base and further utilizes the code understanding model 642 to generate output predictions related to context of the code base. For example, the autonomous software agent system 100 connects to code repositories and creates knowledge inputs/suggestions based on processing the information in the code repository.

To illustrate, the autonomous software agent system 100 can read through documentation/specifications and distill that information into data that is relevant for the code understanding model 642 of the autonomous software agent system 100. In addition, after generating the index of the code repository, the autonomous software agent system 100 further stores the index in the data layer 630 and/or uses the development operations and monitoring layer 648 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates response to prompts. In some embodiments, the autonomous software agent system 100 receives prompts from the frontend layer 608 submitted via an interface (or where the autonomous software agent system 100 intakes prompt, whether via the web application, a messaging application, or otherwise) and are sent to the backend services 616 of the autonomous software agent system 100, where the prompt is processed by the one or more artificial intelligence components (e.g., Devin’s brain).

As shown in FIG. 6, the autonomous software agent system 100 utilizes the client layer 600 to receive interactions. In particular, users can submit a prompt or a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and further create sessions by tagging an autonomous software agent in their team’s messaging server.

As just mentioned, the messaging application integration allows for development sessions to be created by tagging/mentioning an autonomous software agent. In some embodiments, the autonomous software agent system 100 receives from a third-party messaging application between a plurality of users, a mention that tags the autonomous software agent to execute the software task. Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 644 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 6. In particular, the autonomous software agent system 100 includes a natural language processing component (e.g., Devin’s Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in Application No. 19/224,222 PROVIDING INTELLIGENT SEARCH FUNCTIONALITY OF A CODE REPOSITORY VIA AN AUTONOMOUS SOFTWARE AGENT which was filed on May 30^{th}, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a browser, etc.). Moreover, the autonomous software agent system 100 allows a development box to be customized in a user’s workspace (e.g., Devin’s Workspace), where the user can save a specific machine snapshot that the autonomous software agent system 100 will use each time it spins up a new development box.

In one or more embodiments, knowledge may persist across development sessions while the independent virtual machine computing environment remains session-isolated. For example, although each development box is independently instantiated, knowledge retrieval occurs from a shared knowledge library that is external to the isolated virtual machine. In some embodiments, the autonomous software agent system 100 selectively transfers knowledge items into the independent virtual machine computing environment at runtime without permanently embedding such knowledge into the machine snapshot. Thus, knowledge inheritance across sessions may occur logically without contaminating the underlying machine state.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In rolling back to an earlier point in time, the autonomous software agent system 100 rolls back both the state of “Devin’s brain” (e.g., the knowledge and the progress on a certain task), as well as the state of Devin’s machine (e.g., the machine contents).

Moreover, in some embodiments, the autonomous software agent system 100 offers a virtual private cloud (VPC) deployment solution that allows development boxes to run within a customer’s (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 640, the data layer 630, the backend services 616, and the frontend layer 608 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 646. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

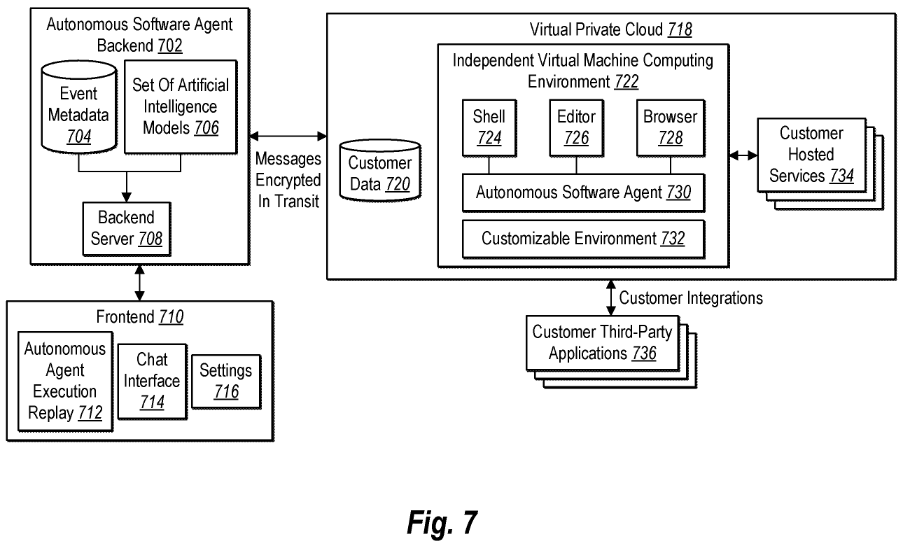

FIG. 7 illustrates additional details of the architecture of the autonomous software agent system 100 in accordance with one or more embodiments. For example, FIG. 7 shows that for each session of deploying an autonomous software agent, the autonomous software agent system 100 spins up/deploys an autonomous software agent backend 702 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 706. As mentioned above, the set of artificial intelligence models 706 contains one or more machine learning/artificial intelligence models shown above used to process, analyze, and generate data.

As shown in FIG. 7, the autonomous software agent backend 702 includes event metadata 704 (e.g., context surrounding a prompt/request submitted to a web application interface, a response to the prompt, or other external sources that contain contextual data), the set of artificial intelligence models 706 (e.g., one or more machine learning models shown and discussed in FIG. 6), and a backend server 708 (e.g., a server that handles logic, database interactions, authentication, and other services for deploying an autonomous software agent).

Further, FIG. 7 shows the autonomous software agent backend 702 interacting with a frontend 710 which includes autonomous agent execution replay 712 (e.g., replay for a timelapse of a development session, a session replay that is a recording of previous user interactions with the autonomous software agent system 100), chat UI 714 (e.g., the graphical user interface provided to a user to submit prompts), and settings 716 (e.g., custom settings established by the autonomous software agent system 100 or by a user).

Moreover, the autonomous software agent backend 702 communicates with a virtual private cloud 718 (e.g., a customer virtual private cloud, which is a dedicated and isolated virtual network within a public cloud service) via encrypted messages. In particular, FIG. 7 shows an independent virtual machine computing environment 722 hosted on the virtual private cloud 718 and the virtual private cloud 718 further includes customer data 720.

Additionally, the independent virtual machine computing environment 722 further includes a shell 724, an editor 726 (e.g., integrated development environment), a browser 728, an autonomous software agent 730, a customizable environment 732 (e.g., playbooks, knowledge, etc. that customize an independent virtual machine computing environment) and customer hosted services 734 (e.g., services or applications hosted and managed by a tenant organization). Additionally, FIG. 7 shows that the virtual private cloud 718 can integrate various applications via access tokens/API keys. In particular, the autonomous software agent system can use the independent virtual machine computing environment 722 (e.g., the autonomous software agent) to write various code and make integrations with applications integrated with the virtual private cloud 718 (e.g., customer third-party applications 736).

As used herein, a browser 728 (or browser tool) refers to a software component executing within an independent virtual machine computing environment and configured to retrieve, render, interpret, and interact with network-accessible resources on behalf of an autonomous software agent system 100. A browser tool operates as a controlled network interaction interface within the independent virtual machine computing environment and provides the autonomous software agent system 100 with programmatic access to web content, application interfaces, documentation repositories, APIs, development resources, and other remote computing services. A browser tool may implement one or more communication protocols, including HTTP, HTTPS, WebSocket, or other network transport protocols.

In the context of the autonomous software agent system 100, a browser tool 210 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool is configured to expose structured outputs—such as DOM trees, accessibility trees, rendered text, event traces, console logs, or network traces—rather than or in addition to graphical output. A browser tool may operate in headless mode and may be programmatically controlled via an automation interface.

A browser tool, as part of the independent virtual machine computing environment, is isolated from a host computing system and subject to resource constraints, execution monitoring, and security policies defined by the independent virtual machine computing environment. This isolation permits the autonomous software agent system 100 to perform research, dependency resolution, API inspection, automated testing of web applications, or code retrieval without exposing the host environment to uncontrolled network interactions. Unless expressly limited, a browser tool encompasses any web client, headless browsing engine, embedded rendering engine, automated browsing framework, or network-interaction module configured to retrieve and interact with remote content within a virtualized execution environment controlled by the autonomous software agent system 100.

In some embodiments, the editor 726 (or integrated development environment (IDE)) refers to an editor tool to write computer code and computer tests. In some embodiments, the integrated development environment is a software application that brings together software tools for software development. In particular, the integrated development environment refers to a software application that combines essential software development features (e.g., coding, debugging, testing, and deployment) to increase the efficiency of completing software projects. The IDE may further maintain structured representations of a project state, including file hierarchies, dependency graphs, abstract syntax trees (ASTs), symbol tables, error diagnostics, execution traces, and build artifacts. In the context of the autonomous software agent system 100, the IDE is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

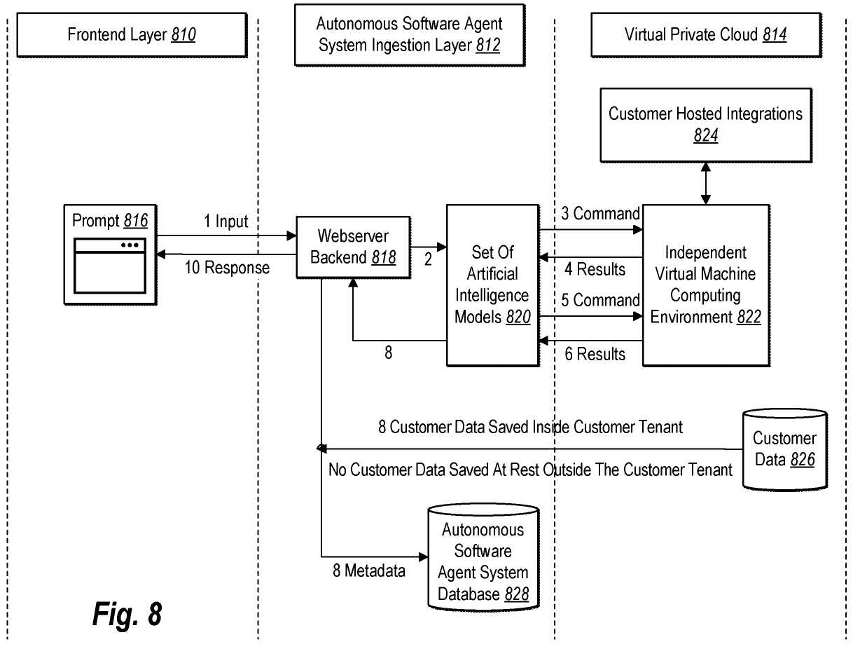

Further, FIG. 8 shows that the autonomous software agent system 100 receives a prompt 816 via a frontend layer 810. As shown, the autonomous software agent system 100 passes the prompt 816 to an autonomous software agent system ingestion layer 812. In response to the prompt 816, the autonomous software agent system 100 responds to the prompt 816 with a webserver backend 818 and further passes the information to a set of artificial intelligence models 820 (e.g., one or more artificial intelligence models shown above in FIG. 6).

As further shown in FIG. 8, the autonomous software agent system 100 passes commands/results back and forth between a virtual private cloud 814 (e.g., an independent virtual machine computing environment 822) and the set of artificial intelligence models 820. In other words, FIG. 8 illustrates the interaction between the frontend layer 810 of the autonomous software agent system 100, the backend of the autonomous software agent system 100, and an autonomous software agent deployed for performing tasks at the virtual private cloud 814. Furthermore, the independent virtual machine computing environment 822 also accesses customer hosted integrations 824 at the virtual private cloud 814.

Additionally, FIG. 8 shows customer data 826 at the virtual private cloud 814 which the autonomous software agent system 100 passes customer data saved inside the customer tenant to the tenant (e.g., and no customer data is saved at rest outside the customer tenant). Moreover, FIG. 8 shows the autonomous software agent system 100 using the webserver backend 818 to pass metadata to an autonomous software agent system database 828.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 822 to communicate with the set of artificial intelligence models 820 (e.g., the artificial intelligence components shown in FIG. 6) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determine a weight for each word within the text prompt to generate a text vector that captures the importance of words within a text prompt, iii) generate low-dimensional text vectors in a continuous vector space that represents words within the text prompt, and/or iv) generate contextualized text vectors by determining semantic relationships between words within the text prompt.

Furthermore, although not shown in FIGS. 7-9, in one or more embodiments, the autonomous software agent system trains the set of artificial intelligence models 820 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining a relevance of certain portions of a website domain page.

Moreover, the autonomous software agent system 100 trains the set of artificial intelligence models 820 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 820). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 7-8 describe various architectural details of the autonomous software agent system 100. In particular, the architectural components of the autonomous software agent system 100 enable an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code revies (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

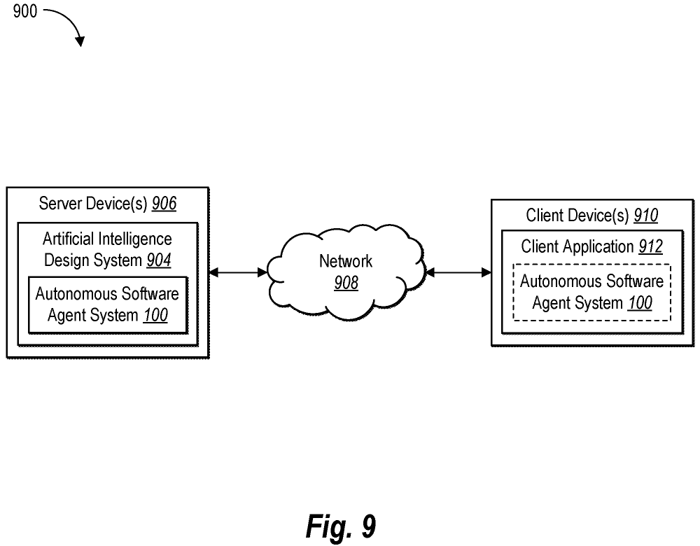

Additional details regarding the autonomous software agent system 100 will now be provided with reference to the figures. For example, FIG. 9 illustrates a schematic diagram of an exemplary system environment 900 in which an autonomous software agent system 100 operates. As illustrated in FIG. 9, the system environment 900 includes server device(s) 906, an artificial intelligence design system 904, a network 908, and client device(s) 910. Additionally, FIG. 9 illustrates that the artificial intelligence design system 904 includes the autonomous software agent system 100.

Although the system environment 900 of FIG. 9 is depicted as having a particular number of components, the system environment 900 is capable of having a different number of additional or alternative components (e.g., a different number of servers, client devices, or other components in communication with the autonomous software agent system 100 via the network 908). Similarly, although FIG. 9 illustrates a particular arrangement of the server device(s) 906, the network 908, and the client device(s) 910, various additional arrangements are possible.

The server device(s) 906, the network 908, and the client device(s) 910 are communicatively coupled with each other either directly or indirectly (e.g., through the network 908 discussed in greater detail below). Moreover, the server device(s) 906 and the client device(s) 910 include one or more of a variety of computing devices (including one or more computing devices as discussed in greater detail below).

As mentioned above, the system environment 900 includes the server device(s) 906. In one or more embodiments, the server device(s) 906 process input for a request (e.g., a request to configure an autonomous software agent or to deploy an autonomous software agent). In one or more embodiments, the server device(s) 906 comprise a data server. In some implementations, the server device(s) 906 comprise a communication server or a web-hosting server. Furthermore, the server device(s) 906 can be associated with the autonomous software agent system 100 or with an organization/company that deploys the autonomous software agent system 100.

In some embodiments, the client device(s) 910 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 910 includes smartphones, tablets, desktop computers, laptop computers, head-mounted-display devices, or other electronic devices. The client device(s) 910 includes one or more software applications (e.g., the client application 912) for generating content in accordance with the artificial intelligence design system 904. In one or more embodiments, the client application 912 includes a software application hosted on the server device(s) 906 accessible by the client device(s) 910 through another application, such as a web browser.

To provide an example implementation, in some embodiments, the autonomous software agent system 100 on the server device(s) 906 supports the autonomous software agent system 100 on the client device(s) 910. For instance, in some cases, the artificial intelligence design system 904 on the server device(s) 906 gathers data for the autonomous software agent system 100. In response, the autonomous software agent system 100, via the server device(s) 906, provides the information to the client device(s) 910. In other words, the client device(s) 910 obtains (e.g., downloads) the autonomous software agent system 100 from the server device(s) 906 that is already trained/optimized. Once downloaded, the autonomous software agent system 100 on the client device(s) 910 is able to perform tasks (e.g., generative software tasks) independent from the server device(s) 906. In one or more alternative implementations, the autonomous software agent system 100 generates or learns parameters for one or more artificial intelligence models (e.g., used to implement an autonomous software agent) in whole or in part on the client device(s) 910.

In alternative implementations, the artificial intelligence design system 904 includes a web hosting application that allows the client device(s) 910 to interact with content and services hosted on the server device(s) 906. To illustrate, in one or more implementations, the client device(s) 910 accesses a software application supported by the server device(s) 906. In response, the artificial intelligence design system 904 on the server device(s) 906 provides tools for monitoring/modifying/generating artificial intelligence outputs using the autonomous software agent. In other words, the client device(s) 910 does not have to download the autonomous software agent system 100 while still being able to access/utilize the trained/optimized tools provided by the artificial intelligence design system 904 via a web hosting application.

In some embodiments, the autonomous software agent system 100 is implemented in whole, or in part, by the individual elements of the system environment 900. For instance, although FIG. 9 illustrates the autonomous software agent system 100 implemented or hosted on the server device(s) 906, different components of the autonomous software agent system 100 are able to be implemented by a variety of devices within the system environment 900. For example, one or more (or all) components of the autonomous software agent system 100 are implemented by a different computing device or a separate server from the server device(s) 906. Indeed, as shown in FIG. 9, the client device(s) 910 includes the autonomous software agent system 100.

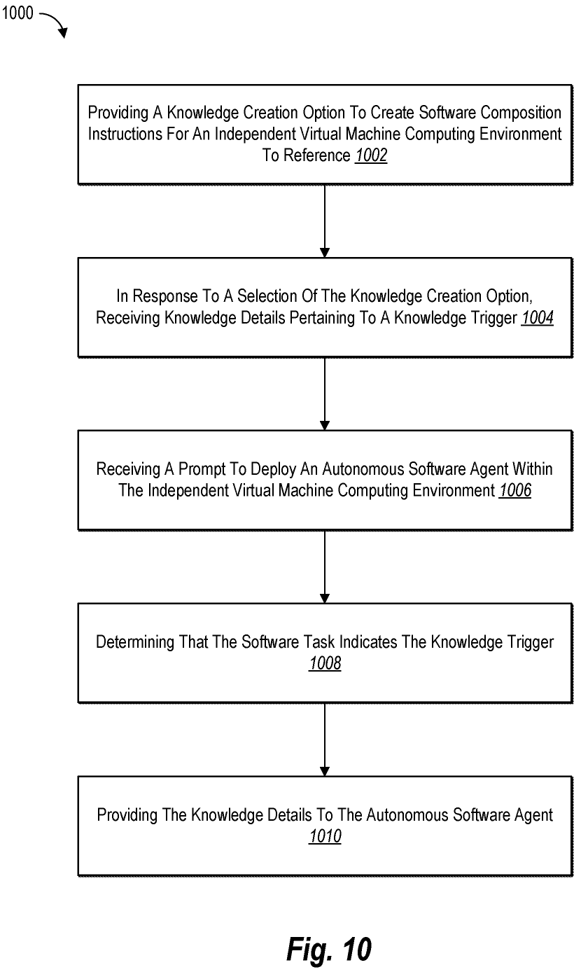

FIG. 10 illustrates a flowchart of a series of acts 1000 for providing knowledge items to an autonomous software agent in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a method. For example, in some embodiments, the acts of FIG. 10 are performed as part of a computer-implemented method. Alternatively, a non-transitory computer-readable medium stores instructions thereon that, when executed by at least one processor, cause a computing device to perform the acts of FIG. 10. In some embodiments, a system performs the acts of FIG. 10. For example, in one or more embodiments, a system includes at least one memory device. The system further includes at least one server device configured to cause the system to perform the acts of FIG. 10.

The series of acts 1000 includes an act 1002 of providing a knowledge creation option to create software composition instructions for an independent virtual machine computing environment to reference. Further, the series of acts 1000 includes an act 1004 of in response to a selection of the knowledge creation option, receiving knowledge items pertaining to a knowledge trigger. Moreover, the series of acts 1000 includes an act 1006 of receiving a prompt to deploy an autonomous software agent within the independent virtual machine computing environment. Furthermore, the series of acts 1000 includes an act 1008 of determining that the software task indicates the knowledge trigger. Additionally, the series of acts 1000 includes an act 1010 of providing the knowledge items to the autonomous software agent.

In particular, the act 1002 includes providing, for display via a knowledge transfer interface, a knowledge creation option to create software composition instructions for an independent virtual machine computing environment to reference across different development sessions. Further, the act 1004 includes in response to a selection of the knowledge creation option, receiving, from the knowledge transfer interface, knowledge items pertaining to a knowledge trigger, wherein the knowledge trigger indicates when the independent virtual machine computing environment references the knowledge items. Moreover, the act 1006 includes receiving, via a graphical user interface, a prompt to deploy an autonomous software agent within the independent virtual machine computing environment to execute a software task in a first development session. Additionally, the act 1008 includes determining that the software task comprises one or more sub-tasks that indicate the knowledge trigger. Furthermore, the act 1010 includes providing the knowledge items to the autonomous software agent to execute the software task in the first development session. Moreover, the series of acts 1000 includes the following clauses.

Clause 1. A computer-implemented method comprising: providing, for display via a knowledge transfer interface, a knowledge creation option to create software composition instructions for an independent virtual machine computing environment to reference across different development sessions; in response to a selection of the knowledge creation option, receiving, from the knowledge transfer interface, knowledge items pertaining to a knowledge trigger, wherein the knowledge trigger indicates when the independent virtual machine computing environment references the knowledge items; receiving, via a graphical user interface, a prompt to deploy an autonomous software agent within the independent virtual machine computing environment to execute a software task in a first development session; determining that the software task comprises one or more sub-tasks that indicate the knowledge trigger; and providing the knowledge items to the autonomous software agent to execute the software task in the first development session.

Clause 2. The computer-implemented method of clause 1, wherein receiving the knowledge items comprises receiving at least one of access to computer code documentation, access to one or more internal code libraries, access to contextual tips for operating within the one or more internal code libraries, or access to one or more skills.

Clause 3. The computer-implemented method of any of clauses 1-2, further comprising customizing the independent virtual machine computing environment according to the knowledge items by providing access to at least one of the computer code documentation, the one or more internal code libraries, the contextual tips, or the one or more skills.

Clause 4. The computer-implemented method of any of clauses 1-3, wherein receiving the knowledge trigger via the graphical user interface comprises: receiving a first knowledge trigger of a sub-task indicating a specific code repository; receiving a second knowledge trigger of the sub-task indicating conversion of a first computer code language to a second computer code language; receiving a third knowledge trigger of the sub-task indicating a deployment of a local application; or receiving a fourth knowledge trigger of the sub-task indicating a data manipulation.

Clause 5. The computer-implemented method of any of clauses 1-4, wherein: receiving the first knowledge trigger comprises receiving access to computer code documentation customized for operating within the specific code repository; receiving the second knowledge trigger comprises receiving access to a specialized skill to convert the first computer code language to the second computer code language; receiving the third knowledge trigger comprises receiving access to contextual tips and a set of customized tests to deploy the local application; or receiving the fourth knowledge trigger comprises receiving access to additional contextual tips and an additional specialized skill to perform the data manipulation.

Clause 6. The computer-implemented method of any of clauses 1-5, wherein determining that the one or more sub-tasks indicate the knowledge trigger further comprises: transmitting, from executing a first sub-task of the software task, context of the first sub-task and a large language model relevance prompt to a large language model; and generating, utilizing the large language model, an artificial intelligence output that indicates that the first sub-task indicates the knowledge trigger.

Clause 7. The computer-implemented method of any of clauses 1-6, further comprising: transmitting the artificial intelligence output from the large language model to the autonomous software agent; and providing the knowledge items to the autonomous software agent based on the artificial intelligence output indicating that the first sub-task indicates the knowledge trigger.

Clause 8. The computer-implemented method of any of clauses 1-7, further comprising: receiving, from the graphical user interface, an additional prompt to deploy an additional autonomous software agent that operates within an additional independent virtual machine computing environment to execute an additional software task in a second development session; determining that the additional software task comprises one or more additional sub-tasks that indicates the knowledge trigger; and providing the knowledge items to the additional autonomous software agent to execute the additional software task in the second development session.

Clause 9. A system comprising: one or more memory devices; and one or more processors coupled to the one or more memory devices, configured to cause the system to: configure an independent virtual machine computing environment with an initial knowledge state by: receiving, via a graphical user interface, a knowledge comprising at least one of computer code documentation, internal code libraries, contextual tips for operating within the internal code libraries, or skills for operating within the internal code libraries; receiving, via the graphical user interface, a knowledge trigger for the independent virtual machine computing environment to reference the knowledge; in response to receiving a prompt to execute a software task, determining that the software task indicates the knowledge trigger; and deploying an autonomous software agent that operates within the independent virtual machine computing environment with access to the knowledge.

Clause 10. The system of clause 9, wherein the one or more processors are configured to cause the system to: customize the independent virtual machine computing environment according to the knowledge by providing access to at least one of the computer code documentation, the internal code libraries, the contextual tips for operating within the internal code libraries, or the skills, wherein the knowledge further comprise access to a specialized skill to convert a first computer code language to a second computer code language, or access to contextual tips and a set of customized tests to deploy a local application.

Clause 11. The system of any of clauses 9-10, wherein the one or more processors are configured to cause the system to: transmit, from executing a first sub-task of the software task, context of a first sub-task and a large language model relevance prompt to a large language model; compare, utilizing the large language model, the context of the first sub-task with a plurality of knowledge triggers in a knowledge library; and generate, utilizing the large language model, an artificial intelligence output that indicates that the first sub-task indicates the knowledge trigger.

Clause 12. The system of any of clauses 9-11, wherein the one or more processors are configured to cause the system to: transmit the artificial intelligence output from the large language model to the autonomous software agent; provide the knowledge to the autonomous software agent based on the artificial intelligence output indicating that the first sub-task indicates the knowledge trigger; transmit, from executing a second sub-task of the software task, an additional context of the second sub-task and an additional large language model relevance prompt to the large language model; and generate, utilizing the large language model, an additional artificial intelligence output that indicates that the second sub-task indicates an additional knowledge trigger.

Clause 13. The system of any of clauses 9-12, wherein the one or more processors are configured to cause the system to: in response to receiving an additional prompt to execute an additional software task, deploy an additional autonomous software agent that operates within an additional independent virtual machine computing environment; and prompt the graphical user interface to submit information to assist the additional autonomous software agent in executing the additional software task.

Clause 14. The system of any of clauses 9-13, wherein the one or more processors are configured to cause the system to: receive, via the graphical user interface, the information to assist the additional autonomous software agent in executing the additional software task; and prompt the graphical user interface to save the information as an additional knowledge for future development sessions.

Clause 15. The system of any of clauses 9-14, wherein the one or more processors are configured to cause the system to prompt the graphical user interface to save the information as the additional knowledge by: providing, for display in the graphical user interface, an additional editable knowledge trigger based on the information; and providing, for display in the graphical user interface, editable knowledge items pertaining to the information to assist the additional autonomous software agent.

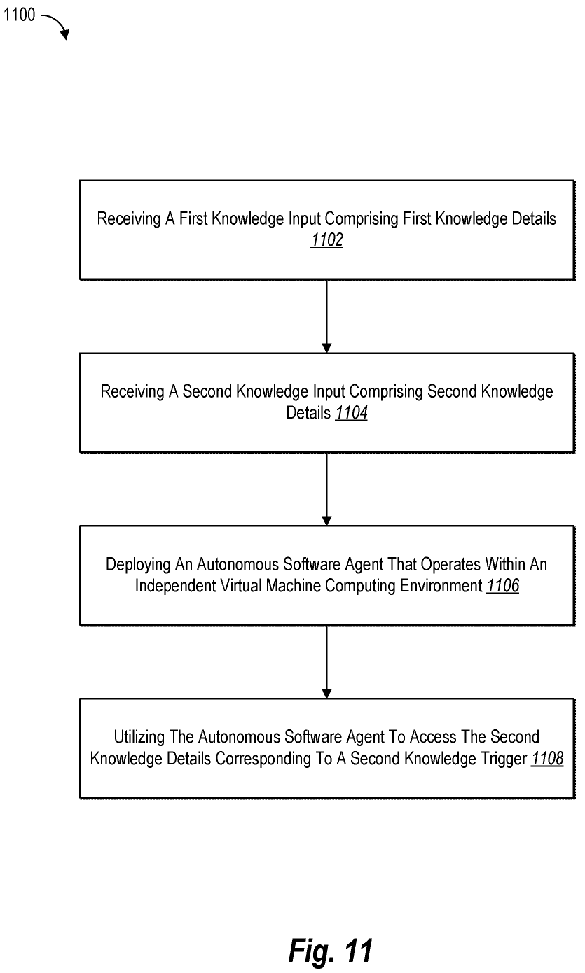

FIG. 11 illustrates a flowchart of a series of acts 1100 for utilizing an autonomous software agent to access second knowledge items corresponding to a second knowledge trigger in accordance with one or more embodiments. FIG. 11 illustrates acts according to one embodiment, alternative embodiments may omit, add to, reorder, and/or modify any of the acts shown in FIG. 11. In some implementations, the acts of FIG. 11 are performed as part of a method. For example, in some embodiments, the acts of FIG. 11 are performed as part of a computer-implemented method. Alternatively, a non-transitory computer-readable medium stores instructions thereon that, when executed by at least one processor, cause a computing device to perform the acts of FIG. 11. In some embodiments, a system performs the acts of FIG. 11. For example, in one or more embodiments, a system includes at least one memory device. The system further includes at least one server device configured to cause the system to perform the acts of FIG. 11.

The series of acts 1100 includes an act 1102 of receiving a first knowledge comprising first knowledge items. Further, the series of acts 1100 includes an act 1104 of receiving a second knowledge comprising second knowledge items. Moreover, the series of acts 1100 includes an act 1106 of deploying an autonomous software agent that operates within an independent virtual machine computing environment. Furthermore, the series of acts 1100 includes an act 1108 of utilizing the autonomous software agent to access the second knowledge items corresponding to a second knowledge trigger.

In particular, the act 1102 includes receiving, from a graphical user interface, a first knowledge comprising first knowledge items corresponding to a first knowledge trigger. Further, the act 1104 includes receiving, from the graphical user interface, a second knowledge comprising second knowledge items corresponding to a second knowledge trigger. Moreover, the act 1106 includes in response to a prompt from the graphical user interface to execute a software task, deploying an autonomous software agent that operates within an independent virtual machine computing environment. Additionally, the act 1108 includes in response to determining that the software task indicates the second knowledge trigger, utilizing the autonomous software agent to access the second knowledge items corresponding to the second knowledge trigger. Moreover, the series of acts 1100 includes the following clauses.

Clause 16. A non-transitory computer-readable medium storing executable instructions which, when executed by at least one processing device, cause the at least one processing device to perform operations comprising: receiving, from a graphical user interface, a first knowledge comprising first knowledge items corresponding to a first knowledge trigger; receiving, from the graphical user interface, a second knowledge comprising second knowledge items corresponding to a second knowledge trigger; in response to a prompt from the graphical user interface to execute a software task, deploying an autonomous software agent that operates within an independent virtual machine computing environment; and in response to determining that the software task indicates the second knowledge trigger, utilizing the autonomous software agent to access the second knowledge items corresponding to the second knowledge trigger.

Clause 17. The non-transitory computer-readable medium of clause 16, wherein receiving, via the graphical user interface, the first knowledge trigger and the second knowledge trigger comprises: receiving an input that pins the first knowledge to a subset of code repositories; and receiving an additional input that pins the second knowledge to an additional subset of code repositories.

Clause 18. The non-transitory computer-readable medium of any of clauses 16-17, further comprising determining that the software task comprises execution of the software task in the additional subset of code repositories.

Clause 19. The non-transitory computer-readable medium of any of clauses 16-18, further comprising: receiving, via the graphical user interface, a third knowledge comprising third knowledge items corresponding to a third knowledge trigger, wherein the third knowledge trigger is not pinned to one or more code repositories; and transmitting, from executing a sub-task of the software task, a context of the sub-task and a large language model relevance prompt to a large language model.

Clause 20. The non-transitory computer-readable medium of any of clauses 16-19, further comprising: comparing, utilizing the large language model, the context of the sub-task with a plurality of knowledge triggers in a knowledge library; generating, utilizing the large language model, an artificial intelligence output that indicates that the sub-task indicates the third knowledge trigger; transmitting the artificial intelligence output from the large language model to the autonomous software agent; and providing the third knowledge to the autonomous software agent based on the artificial intelligence output indicating that the sub-task indicates the third knowledge trigger.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

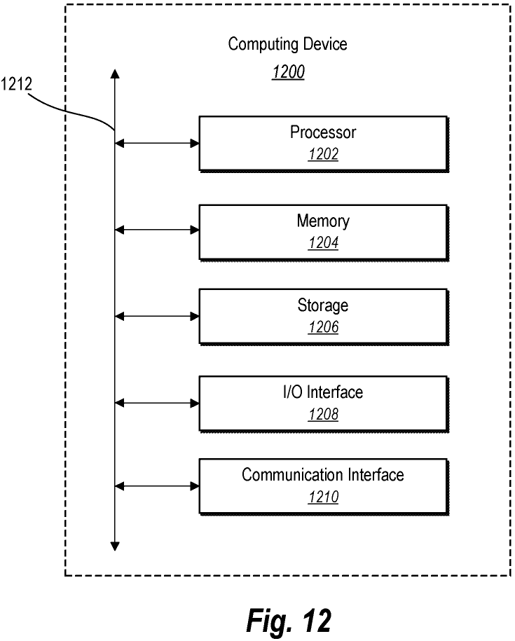

FIG. 12 illustrates a block diagram of an example computing device 1200 that may be configured to perform one or more of the processes described above. One will appreciate that one or more computing devices, such as the computing device 1200 may represent the computing devices described above (e.g., the server device(s) 906 and/or the client device(s) 910). In one or more embodiments, the computing device 1200 may be a mobile device (e.g., a mobile telephone, a smartphone, a PDA, a tablet, a laptop, a camera, a tracker, a watch, a wearable device). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 include hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 including storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
providing, for display via a knowledge transfer interface, a knowledge creation option to create software composition instructions for an independent virtual machine computing environment to reference across different development sessions;
in response to a selection of the knowledge creation option, receiving, from the knowledge transfer interface, knowledge items pertaining to a knowledge trigger, wherein the knowledge trigger indicates when the independent virtual machine computing environment references the knowledge items;
receiving, via a graphical user interface, a prompt to deploy an autonomous software agent within the independent virtual machine computing environment to execute a software task in a first development session;
determining that the software task comprises one or more sub-tasks that indicate the knowledge trigger; and
providing the knowledge items to the autonomous software agent to execute the software task in the first development session.

2. The computer-implemented method of claim 1, wherein receiving the knowledge items comprises receiving at least one of access to computer code documentation, access to one or more internal code libraries, access to contextual tips for operating within the one or more internal code libraries, or access to one or more skills.

3. The computer-implemented method of claim 2, further comprising customizing the independent virtual machine computing environment according to the knowledge items by providing access to at least one of the computer code documentation, the one or more internal code libraries, the contextual tips, or the one or more skills.

4. The computer-implemented method of claim 1, wherein receiving the knowledge trigger via the graphical user interface comprises:
receiving a first knowledge trigger of a sub-task indicating a specific code repository;
receiving a second knowledge trigger of the sub-task indicating conversion of a first computer code language to a second computer code language;
receiving a third knowledge trigger of the sub-task indicating a deployment of a local application; or
receiving a fourth knowledge trigger of the sub-task indicating a data manipulation.

5. The computer-implemented method of claim 4, wherein:
receiving the first knowledge trigger comprises receiving access to computer code documentation customized for operating within the specific code repository;
receiving the second knowledge trigger comprises receiving access to a specialized skill to convert the first computer code language to the second computer code language;
receiving the third knowledge trigger comprises receiving access to contextual tips and a set of customized tests to deploy the local application; or
receiving the fourth knowledge trigger comprises receiving access to additional contextual tips and an additional specialized skill to perform the data manipulation.

6. The computer-implemented method of claim 1, wherein determining that the one or more sub-tasks indicates the knowledge trigger further comprises:
transmitting, from executing a first sub-task of the software task, context of the first sub-task and a large language model relevance prompt to a large language model; and
generating, utilizing the large language model, an artificial intelligence output that indicates that the first sub-task indicates the knowledge trigger.

7. The computer-implemented method of claim 6, further comprising:
transmitting the artificial intelligence output from the large language model to the autonomous software agent; and
providing the knowledge items to the autonomous software agent based on the artificial intelligence output indicating that the first sub-task indicates the knowledge trigger.

8. The computer-implemented method of claim 1, further comprising:
receiving, from the graphical user interface, an additional prompt to deploy an additional autonomous software agent that operates within an additional independent virtual machine computing environment to execute an additional software task in a second development session;
determining that the additional software task comprises one or more additional sub-tasks that indicate the knowledge trigger; and
providing the knowledge items to the additional autonomous software agent to execute the additional software task in the second development session.

9. A system comprising:
one or more memory devices; and
one or more processors coupled to the one or more memory devices, configured to cause the system to:
configure an independent virtual machine computing environment with an initial knowledge state by:
receiving, via a graphical user interface, a knowledge comprising at least one of computer code documentation, internal code libraries, contextual tips for operating within the internal code libraries, or skills for operating within the internal code libraries;
receiving, via the graphical user interface, a knowledge trigger for the independent virtual machine computing environment to reference the knowledge;
in response to receiving a prompt to execute a software task, determining that the software task indicates the knowledge trigger; and
deploying an autonomous software agent that operates within the independent virtual machine computing environment with access to the knowledge.

10. The system of claim 9, wherein the one or more processors are configured to cause the system to:
customize the independent virtual machine computing environment according to the knowledge by providing access to at least one of the computer code documentation, the internal code libraries, the contextual tips for operating within the internal code libraries, or the skills,
wherein the knowledge further comprise access to a specialized skill to convert a first computer code language to a second computer code language, or access to contextual tips and a set of customized tests to deploy a local application.

11. The system of claim 10, wherein the one or more processors are configured to cause the system to:
transmit, from executing a first sub-task of the software task, context of a first sub-task and a large language model relevance prompt to a large language model;
compare, utilizing the large language model, the context of the first sub-task with a plurality of knowledge triggers in a knowledge library; and
generate, utilizing the large language model, an artificial intelligence output that indicates that the first sub-task indicates the knowledge trigger.

12. The system of claim 11, wherein the one or more processors are configured to cause the system to:
transmit the artificial intelligence output from the large language model to the autonomous software agent;
provide the knowledge to the autonomous software agent based on the artificial intelligence output indicating that the first sub-task indicates the knowledge trigger;
transmit, from executing a second sub-task of the software task, an additional context of the second sub-task and an additional large language model relevance prompt to the large language model; and
generate, utilizing the large language model, an additional artificial intelligence output that indicates that the second sub-task indicates an additional knowledge trigger.

13. The system of claim 9, wherein the one or more processors are configured to cause the system to:
in response to receiving an additional prompt to execute an additional software task, deploy an additional autonomous software agent that operates within an additional independent virtual machine computing environment; and
prompt the graphical user interface to submit information to assist the additional autonomous software agent in executing the additional software task.

14. The system of claim 13, wherein the one or more processors are configured to cause the system to:
receive, via the graphical user interface, the information to assist the additional autonomous software agent in executing the additional software task; and
prompt the graphical user interface to save the information as an additional knowledge for future development sessions.

15. The system of claim 14, wherein the one or more processors are configured to cause the system to prompt the graphical user interface to save the information as the additional knowledge by:
providing, for display in the graphical user interface, an additional editable knowledge trigger based on the information; and
providing, for display in the graphical user interface, editable knowledge items pertaining to the information to assist the additional autonomous software agent.

16. A non-transitory computer-readable medium storing executable instructions which, when executed by at least one processing device, cause the at least one processing device to perform operations comprising:
receiving, from a graphical user interface, a first knowledge comprising first knowledge items corresponding to a first knowledge trigger;
receiving, from the graphical user interface, a second knowledge comprising second knowledge items corresponding to a second knowledge trigger;
in response to a prompt from the graphical user interface to execute a software task, deploying an autonomous software agent that operates within an independent virtual machine computing environment; and
in response to determining that the software task indicates the second knowledge trigger, utilizing the autonomous software agent to access the second knowledge items corresponding to the second knowledge trigger.

17. The non-transitory computer-readable medium of claim 16, wherein receiving, via the graphical user interface, the first knowledge trigger and the second knowledge trigger comprises:
receiving an input that pins the first knowledge to a subset of code repositories; and
receiving an additional input that pins the second knowledge to an additional subset of code repositories.

18. The non-transitory computer-readable medium of claim 17, further comprising determining that the software task comprises execution of the software task in the additional subset of code repositories.

19. The non-transitory computer-readable medium of claim 16, further comprising:
receiving, via the graphical user interface, a third knowledge comprising third knowledge items corresponding to a third knowledge trigger, wherein the third knowledge trigger is not pinned to one or more code repositories; and
transmitting, from executing a sub-task of the software task, a context of the sub-task and a large language model relevance prompt to a large language model.

20. The non-transitory computer-readable medium of claim 19, further comprising:
comparing, utilizing the large language model, the context of the sub-task with a plurality of knowledge triggers in a knowledge library;
generating, utilizing the large language model, an artificial intelligence output that indicates that the sub-task indicates the third knowledge trigger;
transmitting the artificial intelligence output from the large language model to the autonomous software agent; and
provide the third knowledge to the autonomous software agent based on the artificial intelligence output indicating that the sub-task indicates the third knowledge trigger.
